(19) United States
(12) Patent Application Publication
(10) Pub. No.: US 2025/0383683 A1
(43) Pub. Date: Dec. 18, 2025

(54) Clock Signal Generation Circuit, Semiconductor Device, Semiconductor System, and Power Supply Control Device

(71) Applicant: ROHM CO., LTD., KYOTO (JP)

(72) Inventor: Takumi YAMADA, KYOTO (JP)

(21) Appl. No.: 19/233,296

(22) Filed: Jun. 10, 2025

(30) Foreign Application Priority Data
Jun. 17, 2024 (JP) 2024-097164

(51) Int. Cl. G06F 1/08; G06F 1/12

(52) U.S. Cl. CPC G06F 1/08; G06F 1/12

(57) ABSTRACT

A clock signal generation circuit comprises a counter that updates a count value in synchronization with an internal clock signal; a timing setting circuit that sets a sampling timing based on a signal asynchronous to the internal clock signal; a holding circuit that acquires and holds the count value at the sampling timing as a parameter value; a signal generation circuit that generates a modulation signal having characteristics corresponding to the parameter value held in the holding circuit; and an oscillator that generates a target clock signal having a frequency corresponding to the modulation signal.

### TECHNICAL FIELD

The present disclosure relates to a clock signal generation circuit, a semiconductor device, a semiconductor system, and a power supply control device.

### BACKGROUND

A clock signal generation circuit that generates clock signals is incorporated into various devices. For example, there is a switching power supply device (DC/DC converter) that uses a frequency of the clock signal as a switching frequency to perform DC/DC conversion. When the frequency of the clock signal is fixed, a radiated noise at that frequency increases. As a technology to suppress an impact of the radiated noise, there is a spread spectrum technology. By using the spread spectrum technology, the noise is spread over a wide bandwidth, and therefore the substantial impact of the noise can be suppressed.

### PRIOR ART DOCUMENT

### Patent Document

[Patent document 1] International Patent Publication No. 2023-286459.

### BRIEF DESCRIPTION OF THE DRAWINGS

FIG. 1 is an overall configuration diagram of a switching power supply device according to an embodiment of the present disclosure.

FIG. 2 is an illustration diagram of an update operation of a count value according to an embodiment of the present disclosure.

FIG. 3 is a diagram showing how a count value is captured as a parameter value at each sampling timing according to an embodiment of the present disclosure.

FIG. 4 is a diagram showing how a count value is captured as a parameter value at each sampling timing according to an embodiment of the present disclosure.

FIG. 5 is a waveform diagram of one modulation signal according to an embodiment of the present disclosure.

FIG. 6 is a diagram showing a pattern table that defines patterns of multiple modulation signals according to an embodiment of the present disclosure.

FIG. 7 is a diagram showing how characteristics of a modulation signal switch in conjunction with changes in parameter values according to an embodiment of the present disclosure.

FIG. 8 is a diagram showing deformed waveforms of multiple modulation signals according to an embodiment of the present disclosure.

FIG. 9 is an overall configuration diagram of a system including a switching power supply device according to a fourth embodiment belonging to embodiments of the present disclosure.

FIG. 10 is an external perspective view of a power supply control device according to a fourth embodiment belonging to embodiments of the present disclosure.

FIG. 11 is an overall configuration diagram of a switching power supply device according to a fourth embodiment belonging to embodiments of the present disclosure.

FIG. 12 is a diagram showing a relationship between a target clock signal and two gate signals according to a fourth embodiment belonging to embodiments of the present disclosure.

FIG. 13 is a diagram showing a configuration related to communication between a power supply control device and an MPU according to a fourth embodiment belonging to embodiments of the present disclosure.

FIG. 14 is a diagram showing a relationship between a reception timing of a write command and flag data according to a fourth embodiment belonging to embodiments of the present disclosure.

FIG. 15 is a diagram showing a relationship between flag data and sampling timing according to a fourth embodiment belonging to embodiments of the present disclosure.

FIG. 16 is an overall configuration diagram of a switching power supply device according to a fifth embodiment belonging to embodiments of the present disclosure.

FIG. 17 is an illustration diagram of a first setting method of sampling timing based on a frequency-divided clock signal according to a fifth embodiment belonging to embodiments of the present disclosure.

FIG. 18 is an illustration diagram of a second setting method of sampling timing based on a frequency-divided clock signal according to a fifth embodiment belonging to embodiments of the present disclosure.

FIG. 19 is an illustration diagram of a third setting method of sampling timing based on a frequency-divided clock signal according to a fifth embodiment belonging to embodiments of the present disclosure.

FIG. 20 is an illustration diagram of a fourth setting method of sampling timing based on a frequency-divided clock signal according to a fifth embodiment belonging to embodiments of the present disclosure.

FIG. 21 is a configuration diagram of a switching power supply device according to a first reference configuration.

FIG. 22 is a configuration diagram of a switching power supply device according to a second reference configuration.

### DETAILED DESCRIPTION OF THE EMBODIMENTS

Prior to an illustration of a switching power supply device according to embodiments of the present disclosure, switching power supply devices according to first and second reference configurations are illustrated.

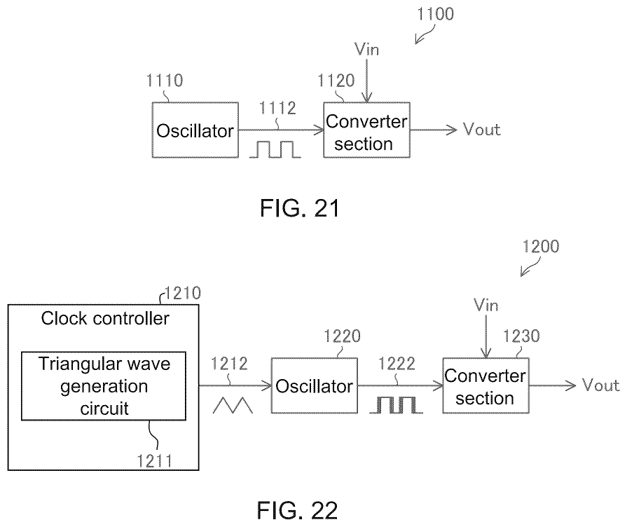

FIG. 21 shows a configuration of a switching power supply device 1100 according to the first reference configuration. The switching power supply device 1100 comprises an oscillator 1110 and a converter section 1120. In the switching power supply device 1100, a rectangular wave signal 1112 having a fixed frequency output from the oscillator 1110 is supplied to the converter section 1120 as a clock signal. The converter section 1120 uses a frequency of a clock signal as a switching frequency to perform a switching operation on an input voltage Vin to generate an output voltage Vout. The input voltage Vin and the output voltage Vout are direct current voltages different from each other. In the configuration of FIG. 21, significant noise occurs at the frequency of the clock signal, and this noise becomes a factor in degrading EMI (Electro Magnetic Interference) characteristics.

FIG. 22 shows a configuration of a switching power supply device 1200 according to the second reference configuration. The switching power supply device 1200 comprises a clock controller 1210, an oscillator 1220, and a converter section 1230. The converter section 1230 is a circuit similar to the converter section 1120 in FIG. 21. A triangular wave signal 1212 is output from a triangular wave generation circuit 1211 provided in the clock controller 1210. The triangular wave signal 1212 is a digital triangular wave signal. The oscillator 1220 supplies a clock signal 1222 having a frequency corresponding to a value of the triangular wave signal 1212 to the converter section 1230. The oscillator 1220 is provided with a DAC (Digital-to-Analog Converter) that receives the triangular wave signal 1212, and a frequency of the clock signal 1222 is determined based on an output of the DAC. By modulating the frequency of the clock signal 1222 based on the triangular wave signal 1212, in the second reference configuration, radiated noise at the switching frequency is reduced compared to the first reference configuration. However, in the second reference configuration, new noise occurs at a frequency of the triangular wave and a harmonic frequency of the triangular wave, which becomes a new factor in degrading EMI characteristics.

In view of these circumstances, the embodiments of the present disclosure are presented below. In each figure referred to in the embodiments of the present disclosure, same portions are denoted by the same reference numerals, and redundant illustrations regarding the same portions are omitted in principle. Furthermore, in this specification, for the sake of simplifying the description, a name of an information, a signal, a physical quantity, a functional part, a circuit, an element, or a component, etc., corresponding to a symbol or reference numeral that refers to the information, the signal, the physical quantity, the functional part, the circuit, the element, or the component, etc. may be omitted or abbreviated by indicating the symbol or reference numeral.

Illustrations are provided for several terms used in a description of the embodiments of the present disclosure. Ground refers to a reference conductor having a reference potential of 0 V (zero volts), or refers to the potential of 0 V itself. The reference conductor may be formed using a conductor such as metal. The potential of 0 V may also be referred to as a ground potential. In the embodiments of the present disclosure, a voltage indicated without any particular reference represents a potential as viewed from the ground. Level refers to a level (height) of potential, and a high level has a potential higher than a low level for any given signal or voltage of interest. In any given signal or voltage of interest, switching from the low level to the high level may be referred to as a rising edge, and switching from the high level to the low level may be referred to as a falling edge.

For any transistor configured as an FET (field-effect transistor) exemplified by a MOSFET, an on state refers to a state where a drain and a source of this transistor are conducting, and an off state refers to a state where the drain and the source of this transistor are non-conducting (a cut-off state). The same applies to transistors that are not classified as FETs. Unless otherwise specified, the MOSFET is understood to be an enhancement-type MOSFET. MOSFET is an abbreviation for “metal-oxide-semiconductor field-effect transistor.” Additionally, unless otherwise specified, in any MOSFET, a backgate may be thought of as short-circuited to a source. Hereinafter, for any transistor, the on state and the off state may simply be expressed as on and off.

For any signal having a signal level of a high level or a low level, a period during which this signal level is the high level is referred to as a high-level period, and a period during which this signal level is the low level is referred to as a low-level period. The same applies to any voltage having a voltage level of a high level or a low level.

Unless otherwise specified, a connection between multiple parts forming a circuit, such as any circuit element, wiring, node, etc., may be understood to refer to an electrical connection.

When any two voltages to be compared are denoted as voltages v1 and v2, “v1>v2” indicates that the voltage v1 is higher than the voltage v2, “v1<v2” indicates that the voltage v1 is lower than the voltage v2, and “v1=v2” indicates that a value of the voltage v1 is the same as a value of the voltage v2. The same applies to other equations that include physical quantities other than voltage.

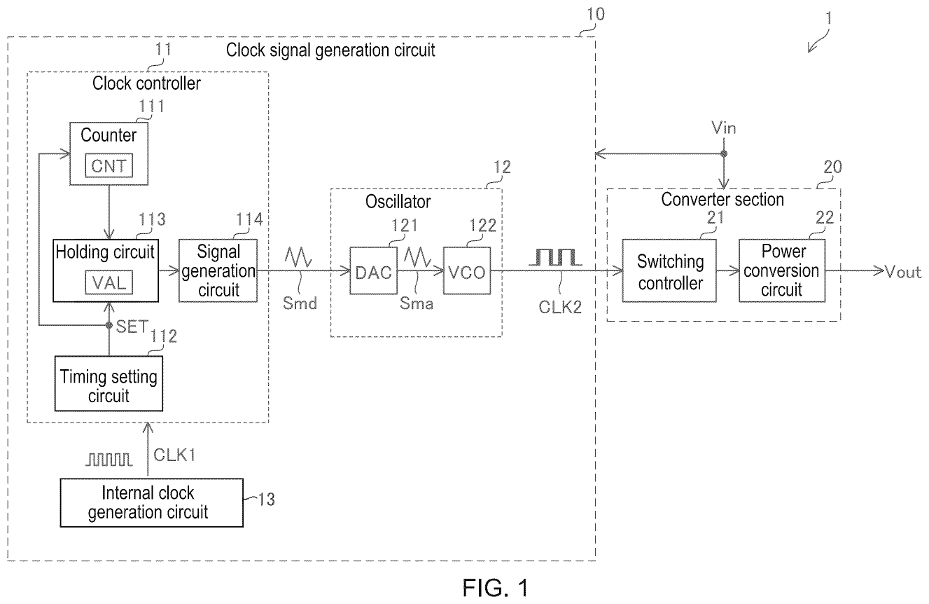

FIG. 1 shows a schematic overall configuration of a switching power supply device 1 according to an embodiment of the present disclosure. The switching power supply device 1 comprises a clock signal generation circuit 10 and a converter section 20. An input voltage Vin is supplied to the switching power supply device 1 from a direct current voltage source which is not shown. The switching power supply device 1 generates an output voltage Vout by power conversion of an input voltage Vin (i.e., converting the input voltage Vin to the output voltage Vout). The input voltage Vin and the output voltage Vout are positive direct current voltages different from each other. The output voltage Vout may be lower than the input voltage Vin, or may be higher than the input voltage Vin. The clock signal generation circuit 10 and the converter section 20 operate based on the input voltage Vin. Some circuits in the clock signal generation circuit 10 and the converter section 20 may operate based on an internal power supply voltage generated based on the input voltage Vin.

The clock signal generation circuit 10 comprises a clock controller 11, an oscillator 12, and an internal clock generation circuit 13. The internal clock generation circuit 13 generates an internal clock signal CLK1 having a predetermined frequency f_{CLK1} for example, 1 megahertz). The internal clock signal CLK1 is a rectangular wave signal alternating between a high level and a low level. The internal clock signal CLK1 is supplied to the clock controller 11. Herein, it is considered that the internal clock generation circuit 13 is provided separately from the clock controller 11, but the internal clock generation circuit 13 may be built in the clock controller 11.

The clock controller 11 comprises a counter 111, a timing setting circuit 112, a holding circuit 113, and a signal generation circuit 114. The counter 111, the timing setting circuit 112, the holding circuit 113, and the signal generation circuit 114 operate in synchronization with the internal clock signal CLK1.

The counter 111 is a circuit that generates and outputs a count value CNT, and performs a counting operation that updates the count value CNT in synchronization with the internal clock signal CLK1. The count value CNT has any integer value equal to or greater than a minimum value Cmin and equal to or less than a maximum value Cmax. The minimum value Cmin and the maximum value Cmax have predetermined integer values satisfying “Cmin<Cmax.” In the following, for the sake of concreteness of illustration, it is assumed that “(Cmin, Cmax)=(0, 15),” unless otherwise specified. Thus, the count value CNT comprises an integer value of 0 or more and 15 or less.

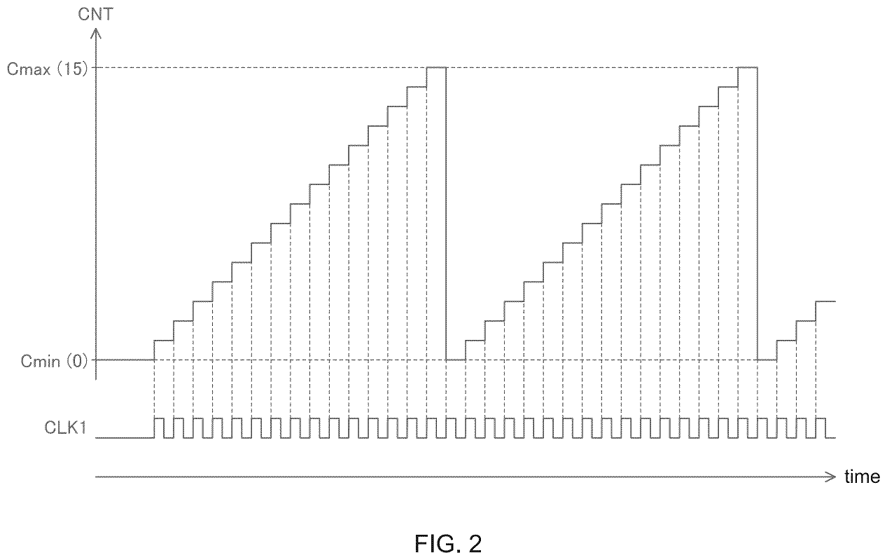

FIG. 2 shows a relationship between the internal clock signal CLK1 and the count value CNT. An initial value of the count value CNT is the minimum value Cmin (i.e., 0). In the counting operation, the counter 111 increases the count value CNT by “1” only each time a rising edge of the internal clock signal CLK1 occurs. An increase in the count value CNT occurs at a timing of the rising edge of the internal clock signal CLK1. However, when the count value CNT matches the maximum value Cmax (herein, 15) and the rising edge of the internal clock signal CLK1 occurs, the counter 111 resets the count value CNT. Resetting the count value CNT refers to assigning the initial value of the count value CNT (herein, 0) to the count value CNT.

As a modification, the initial value of the count value CNT may be set to the maximum value Cmax (i.e., 15), and the counter 111 may decrease the count value CNT by “1” only each time the rising edge of the internal clock signal CLK1 occurs. In this case, when the count value CNT matches the minimum value Cmin (i.e., 0) and the rising edge of the internal clock signal CLK1 occurs, the counter 111 resets the count value CNT. Alternatively, the counter 111 may increase or decrease the count value CNT by “1” only each time a falling edge of the internal clock signal CLK1 occurs.

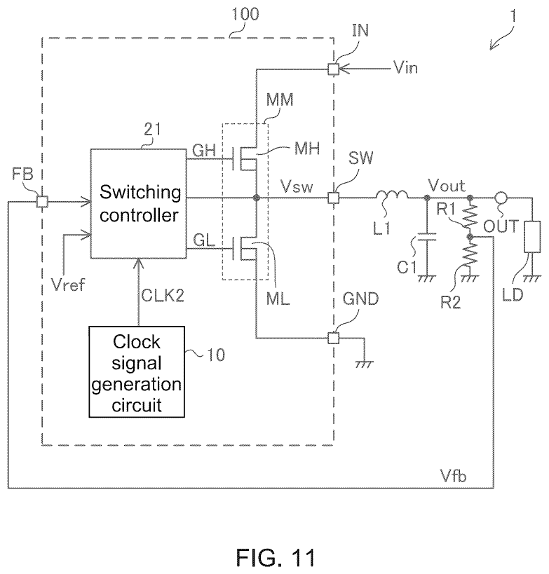

Furthermore, when the input voltage Vin starts to be supplied to a device including the clock signal generation circuit 10 (for example, a power supply control device 100 described later; refer to FIG. 11), the device including the clock signal generation circuit 10 is thereby activated, and then a predetermined initial sequence operation is executed in this device, and after the initial sequence operation is completed, the counting operation by the counter 111 is started. Before the initial sequence operation is completed, the count value CNT has an initial value. Each operation shown below is assumed to be an operation after the initial sequence operation is completed, unless otherwise specified.

The timing setting circuit 112 sets the sampling timing based on a signal asynchronous to the internal clock signal CLK1. The sampling timing is a timing at which the holding circuit 113 acquires the count value CNT from the counter 111. That is, the timing at which the holding circuit 113 acquires the count value CNT from the counter 111 is set (specified) by the timing setting circuit 112. The above asynchronous signal referred to by the timing setting circuit 112 to set the sampling timing (a signal asynchronous to the internal clock signal CLK1) is hereinafter referred to as an asynchronous signal AS. The timing setting circuit 112 sets the sampling timing by generating and outputting a signal SET based on the asynchronous signal AS. The signal SET is a binary signal having a high level or a low level and is supplied to the counter 111 and the holding circuit 113. However, the supply of the signal SET to the counter 111 may be omitted. The signal SET has the low level in principle.

The holding circuit 113 acquires the count value CNT at the sampling timing set by the timing setting circuit 112 and holds it as a parameter value VAL. The holding circuit 113 can be formed by a memory such as a latch circuit. An initial value of the parameter value VAL is arbitrary, but herein it is assumed to be “0.”

The timing setting circuit 112 generates a pulse in the signal SET based on the asynchronous signal AS. A period during which the pulse of the signal SET is generated (i.e., a high-level period of the signal SET) corresponds to the sampling timing, and the holding circuit 113 acquires and holds the count value CNT during the period during which the pulse of the signal SET is generated (i.e., the high-level period of the signal SET) as the parameter value VAL.

The sampling timing is repeatedly set by the timing setting circuit 112 based on the asynchronous signal AS. At each sampling timing, the holding circuit 113 acquires the count value CNT at that sampling timing as a new parameter value VAL, thereby sequentially updating the parameter value VAL held by itself.

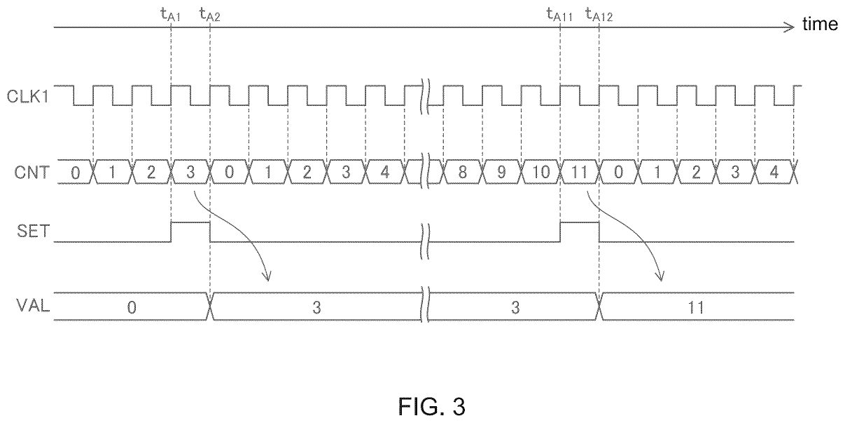

An example of an update operation of the parameter value VAL is shown in FIG. 3. It is assumed that, as time progresses, times t_{A1}, t_{A2}, t_{A11}, and t_{A12} occur in this order. At each of times t_{A1}, t_{A2}, t_{A11}, and t_{A12}, a rising edge occurs in the internal clock signal CLK1, and an update in the count value CNT is performed. In the example of FIG. 3, the counting operation by the counter 111 starts before time t_{A1}. Additionally, before time t_{A1}, the signal SET is maintained at a low level, and the parameter value VAL is maintained at the initial value “0.” The timing setting circuit 112 generates a pulse in the signal SET at each of times t_{A1} and t_{A11} based on the asynchronous signal AS. The timing setting circuit 112 operates in synchronization with the internal clock signal CLK1 and sets a length of the high-level period of the signal SET in the pulse of the signal SET to a length of one period of the internal clock signal CLK1.

Specifically, in the example of FIG. 3, the timing setting circuit 112 generates a rising edge in the signal SET at time t_{A1} and generates a falling edge in the signal SET at time t_{A2}. A length between times t_{A1} and t_{A2} is equal to the length of one period of the internal clock signal CLK1, and the timing setting circuit 112 generates a rising edge in the signal SET at time t_{A1} in synchronization with the rising edge of the internal clock signal CLK1 at time t_{A1} and generates a falling edge in the signal SET at time t_{A2} in synchronization with the rising edge of the internal clock signal CLK1 at time t_{A2}. Subsequently, the timing setting circuit 112 generates a rising edge in the signal SET at time t_{A11} and generates a falling edge in the signal SET at time t_{A12}. A length between times t_{A11} and t_{A12} is equal to the length of one period of the internal clock signal CLK1, and the timing setting circuit 112 generates a rising edge in the signal SET at time t_{A11} in synchronization with the rising edge of the internal clock signal CLK1 at time t_{A11} and generates a falling edge in the signal SET at time t_{A12} in synchronization with the rising edge of the internal clock signal CLK1 at time t_{A12}.

In the example of FIG. 3, the parameter value VAL just before time t_{A1} is “0,” and the count value CNT between times t_{A1} and t_{A2} is “3.” The holding circuit 113 operates in synchronization with the internal clock signal CLK1, and captures and holds the count value CNT of “3” between times t_{A1} and t_{A2} as the parameter value VAL at time t_{A2}. In this case, the holding circuit 113 updates the parameter value VAL held by itself at the end of the high-level period of the signal SET. Thus, the parameter value VAL is updated from “0” to the count value CNT of “3” between times t_{A1} and t_{A2} at time t_{A2}. That is, the parameter value VAL switches from “0” to “3” at time t_{A2}.

In the example of FIG. 3, the parameter value VAL just before time t_{A11} is “3,” and the count value CNT between times tan and t_{A12} is “11.” The holding circuit 113 operates in synchronization with the internal clock signal CLK1, and captures and holds the count value CNT of “11” between times t_{A11} and t_{A12} as the parameter value VAL at time t_{A12}. In this case, the holding circuit 113 updates the parameter value VAL held by itself at the end of the high-level period of the signal SET. Thus, the parameter value VAL is updated from “3” to the count value CNT of “11” between times t_{A11} and t_{A12} at time t_{A12}. That is, the parameter value VAL switches from “3” to “11” at time t_{A12}.

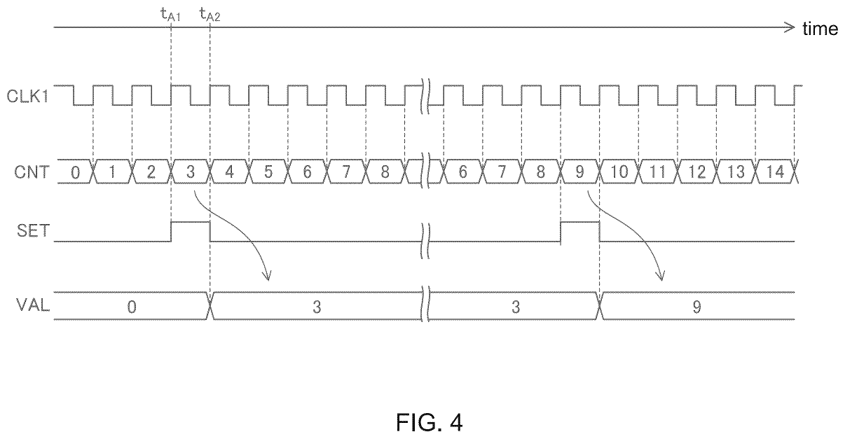

Additionally, after a rising edge occurs in the signal SET, the count value CNT is reset at a timing at which the next rising edge of the internal clock signal CLK1 occurs. Therefore, in the example of FIG. 3, the count value CNT switches from “3” to “0” at time t_{A2}, and the count value CNT switches from “11” to “0” at time t_{A12}. However, the reset of the count value CNT based on the signal SET does not necessarily have to be performed. When the reset of the count value CNT based on the signal SET is not performed, as shown in FIG. 4, the count value CNT is updated from “3” to “4” in response to the rising edge of the internal clock signal CLK1 at time t_{A2}. The same applies when a pulse occurs in the signal SET after time t_{A2}.

In the example of FIG. 3, the entire period between times t_{A1} and t_{A2} or a timing within the period between times t_{A1} and t_{A2} corresponds to the first sampling timing, and the entire period between times t_{A11} and t_{A12} or a timing within the period between times t_{A11} and t_{A12} corresponds to the second sampling timing. Thereafter, multiple sampling timings are sequentially set by repeatedly generating pulses in the signal SET based on the asynchronous signal AS, but an interval between two adjacent sampling timings is much larger than the length of one period of the internal clock signal CLK1. For example, when the length of one period of the internal clock signal CLK1 is 1 microsecond, the interval between two adjacent sampling timings is about several hundreds of microseconds to several tens of milliseconds. While the period of the internal clock signal CLK1 is fixed, the interval between two adjacent sampling timings is not constant and fluctuates somewhat as time progresses.

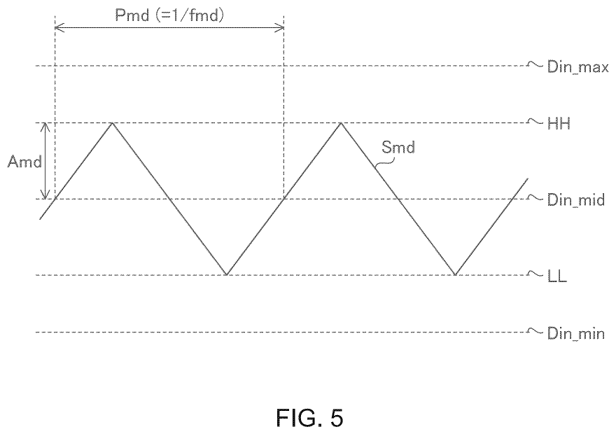

The signal generation circuit 114 generates a modulation signal Smd having characteristics corresponding to the parameter value VAL held in the holding circuit 113 and supplies it to the oscillator 12. The modulation signal Smd is a digital pulsating signal, and consequently, a value of the modulation signal Smd fluctuates over time. For the sake of concreteness of illustration, as shown in FIG. 5, the modulation signal Smd is assumed to be a triangular wave signal herein. A frequency of the modulation signal Smd is referred to as a frequency fmd, and an amplitude of the modulation signal Smd is referred to as an amplitude Amd. A period Pmd of the modulation signal Smd comprises a length that is a reciprocal of the frequency fmd.

A value of the modulation signal Smd fluctuates with an intermediate value Din_mid as a center. That is, the intermediate value Din_mid is equal to a value of a direct current component of the modulation signal Smd. The amplitude Amd is set variously according to the parameter value VAL, but the value of the modulation signal Smd does not exceed an upper limit value Din_max, and the value of the modulation signal Smd does not fall below a lower limit value Din_min. The upper limit value Din_max, the intermediate value Din_mid, and the lower limit value Din_min comprise three predetermined integer values. “0<Din_min<Din_mid<Din_max” and “Din_mid=(Din_max+Din_min)/2” are satisfied. A numerical range from the lower limit value Din_min to the upper limit value Din_max falls within an input dynamic range of a DAC 121 described later.

A minimum value and a maximum value of values of the modulation signal Smd are represented by LL and HH, respectively. The maximum value HH is greater than the minimum value LL. The signal generation circuit 114 repeatedly executes the following signal generation unit operation at the period Pmd of the modulation signal Smd.

In the signal generation unit operation, the signal generation circuit 114 starts from a state where the value of the modulation signal Smd matches the intermediate value Din_mid and linearly and monotonically increases the value of the modulation signal Smd from the intermediate value Din_mid to the maximum value HH at a predetermined rate of increase. In the signal generation unit operation, when the value of the modulation signal Smd increases to the maximum value HH, the signal generation circuit 114 linearly and monotonically decreases the value of the modulation signal Smd from the maximum value HH to the minimum value LL at a predetermined rate of decrease. In the signal generation unit operation, when the value of the modulation signal Smd decreases to the minimum value LL, the signal generation circuit 114 linearly and monotonically increases the value of the modulation signal Smd from the minimum value LL to the intermediate value Din_mid at a predetermined rate of increase. One period of the signal generation unit operation is an operation of starting from a state where the value of the modulation signal Smd matches the intermediate value Din_mid, continuing through an increase to the maximum value HH of the modulation signal Smd and a decrease to the minimum value LL of the modulation signal Smd, and then returning the value of the modulation signal Smd to the intermediate value Din_mid, and takes a time of period Pmd (i.e., a time of the reciprocal of the frequency fmd). The amplitude Amd is equal to an absolute value of a difference between the maximum value HH and the intermediate value Din_mid, and is equal to an absolute value of a difference between the minimum value LL and the intermediate value Din_mid. In the signal generation unit operation, the signal generation circuit 114 updates the value of the modulation signal Smd at the period of the internal clock signal CLK1.

FIG. 6 conceptually shows a pattern table TBL stored in the signal generation circuit 114. As many patterns of the modulation signal Smd as the number of types of numerical values that the parameter value VAL can take are predefined, and their defined content are held in the pattern table TBL. In this embodiment, the parameter value VAL comprises an integer value of 0 or more and 15 or less. Therefore, 16 types of patterns of the modulation signal Smd are predefined, and their defined content are held in the pattern table TBL. The modulation signal Smd associated with the parameter value VAL that satisfies “VAL=i” is specifically referred to as a modulation signal Smd[i], and a frequency and an amplitude of modulation signal Smd[i] are specifically referred to as a frequency fmd[i] and an amplitude Amd[i], respectively (where i represents an integer of 0 or more and 15 or less).

Characteristics of the modulation signals Smd[0] to Smd[15] are different from each other. More specifically, frequencies of the modulation signals Smd[0] to Smd[15] are different from each other (i.e., frequencies fmd[0] to fmd[15] are different from each other). Thus, a rate of change (rate of increase and rate of decrease) of the modulation signal Smd[i_{A}] and a rate of change (rate of increase and rate of decrease) of the modulation signal Smd[i_{B}] are different from each other. Herein, i_{A} and i_{B} represent two integers of 0 or more and 15 or less different from each other. Additionally, amplitudes of the modulation signals Smd[0] to Smd[15] are different from each other (i.e., amplitudes Amd[0] to Amd[15] are different from each other). Thus, a maximum value HH of the modulation signal Smd[i_{A}] and a maximum value HH of the modulation signal Smd[i_{B}] are different from each other, and a minimum value LL of the modulation signal Smd[i_{A}] and a minimum value LL of the modulation signal Smd[i_{B}] are different from each other. The signal generation circuit 114 selects one of modulation signals Smd[0] to Smd[15] according to the parameter value VAL, and outputs the selected modulation signal Smd to the oscillator 12. Therefore, the signal generation circuit 114 variably sets the frequency and the amplitude of the modulation signal Smd output to the oscillator 12 according to the parameter value VAL. Hereinafter, the modulation signal Smd output from the signal generation circuit 114 to the oscillator 12 may be specifically referred to as an output modulation signal Smd.

When the parameter value VAL is “0,” the modulation signal Smd[0] is selected as the output modulation signal Smd and supplied to the oscillator 12, and when the parameter value VAL is “1,” the modulation signal Smd[1] is selected as the output modulation signal Smd and supplied to the oscillator 12. The same applies when the parameter value VAL comprises other values. In general, when “VAL=i,” the modulation signal Smd[i] is selected as the output modulation signal Smd and supplied to the oscillator 12 (where i represents an integer of 0 or more and 15 or less).

The oscillator 12 comprises a DAC 121 and a VCO 122 (refer to FIG. 1). The oscillator 12 generates and outputs a clock signal CLK2 having a frequency corresponding to the modulation signal Smd (i.e., output modulation signal Smd) supplied from the signal generation circuit 114. Hereinafter, to clearly distinguish it from the internal clock signal CLK1, the clock signal CLK2 generated by the oscillator 12 and output from the oscillator 12 is often referred to as the target clock signal CLK2. The target clock signal CLK2, similar to the internal clock signal CLK1, is a rectangular wave signal alternating between a high level and a low level. A frequency of the target clock signal CLK2 is referred to as a frequency f_{CLK2}.

The DAC 121 is a digital-to-analog converter. The output modulation signal Smd is input from the signal generation circuit 114 to the DAC 121. The DAC 121 performs DA conversion processing (digital/analog conversion processing) to convert an input digital signal into an analog signal. Consequently, the DAC 121 converts the digital output modulation signal Smd into an analog signal, a modulation signal Sma, by DA conversion processing, and outputs it. The modulation signal Sma is a voltage signal and comprises an analog voltage value corresponding to a value of the output modulation signal Smd (an analog voltage value proportional to the value of the modulation signal Smd). An execution period of DA conversion processing in the DAC 121 is much shorter than each period of the modulation signals Smd[0] to Smd[15] and may be an integer multiple (including 1) of a period of the internal clock signal CLK1.

The modulation signal Sma output from the DAC 121 is input to the VCO 122. The VCO 122 is a Voltage Controlled Oscillator. The VCO 122 converts the modulation signal Sma into the frequency f_{CLK2}, and generates and outputs the target clock signal CLK2 having the frequency f_{CLK2}. The frequency f_{CLK2} increases as a voltage value of the modulation signal Sma increases and decreases as the voltage value of the modulation signal Sma decreases. The frequency f_{CLK2} is modulated (spread) according to the voltage value of the modulation signal Sma based on a center frequency of the target clock signal CLK2. Furthermore, an amount of change of the frequency f_{CLK2} with respect to a unit amount of change in the voltage value of the modulation signal Sma may be constant throughout an entire range in which the frequency f_{CLK2}changes.

The converter section 20 receives an input voltage Vin from a direct current voltage source which is not shown, and generates and outputs an output voltage Vout by performing DC/DC conversion on the input voltage Vin. The input voltage Vin and the output voltage Vout are direct current voltages comprising voltage values different from each other. The converter section 20 comprises a switching controller 21 and a power conversion circuit 22. A target clock signal CLK2 is input to the converter section 20. The converter section 20 converts the input voltage Vin to the output voltage Vout by performing switching control using a frequency of the target clock signal CLK2 as a switching frequency. More specifically, the power conversion circuit 22 comprises an output stage circuit provided between an application terminal of the input voltage Vin and an application terminal of the output voltage Vout, and the output stage circuit includes at least an output transistor. The switching controller 21 generates the output voltage Vout through switching the output transistor using a frequency of the target clock signal CLK2 as a switching frequency.

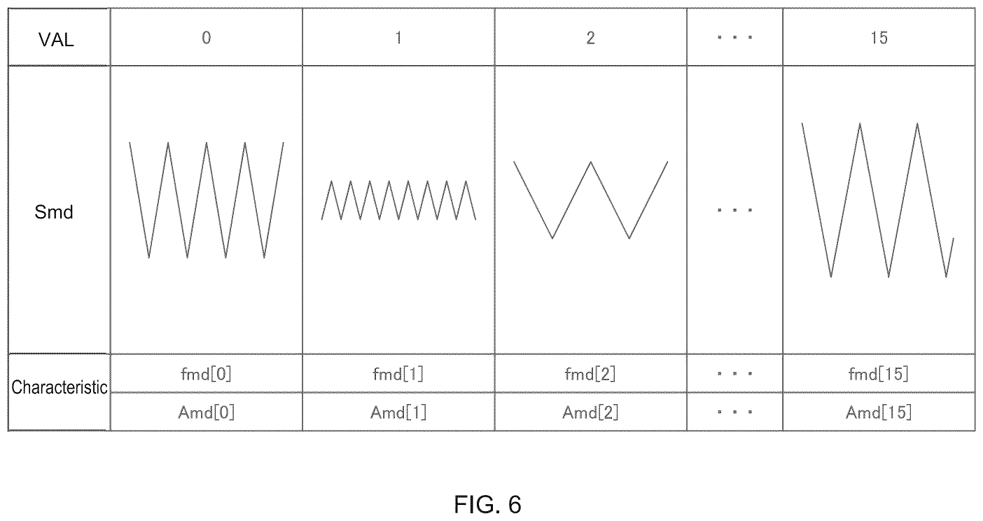

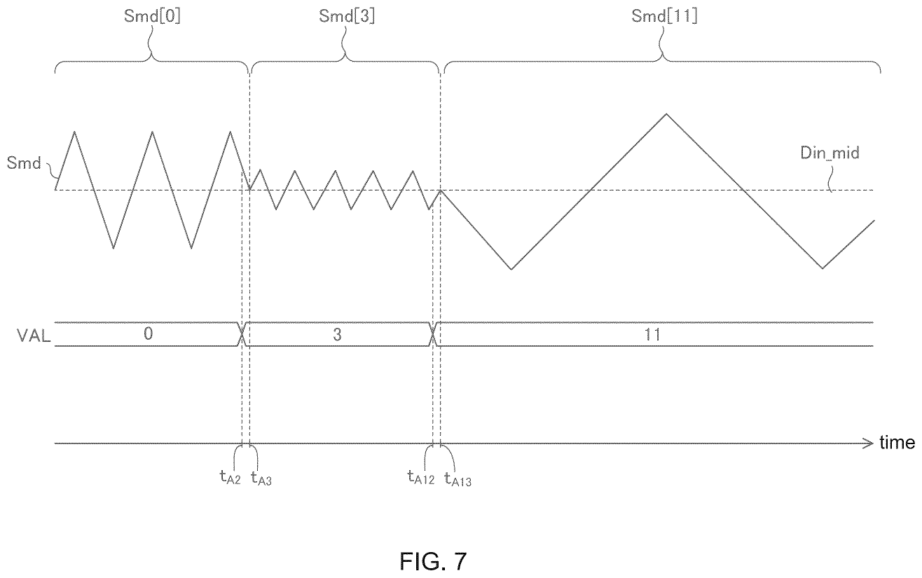

Referring to FIG. 7, a switching operation of the output modulation signal Smd is illustrated. As shown in FIG. 3, it is assumed that before time t_{A2}, the parameter value VAL is maintained at “0,” and at time t_{A2}, the parameter value VAL switches from “0” to “3,” and then at time t_{A12}, the parameter value VAL switches from “3” to “11.” Time t_{A3} is a time after time t_{A2} and before time t_{A12}, and time t_{A13} is a time after time t_{A12}.

The signal generation circuit 114 repeatedly executes the above signal generation unit operation. The holding circuit 113 outputs a read command signal to the signal generation circuit 114 when the parameter value VAL held by itself changes from a certain value i_{A} to another value i_{B} (where the values i_{A} and i_{B} are integer values of 0 or more and 15 or less different from each other). Upon receiving the read command signal, the signal generation circuit 114 reads the latest parameter value VAL held in the holding circuit 113 and then switches the output modulation signal Smd from the modulation signal Smd[i_{A}] to the modulation signal Smd[i_{B}] at a waveform update timing. In the operation related to FIG. 7, the waveform update timing is a timing among timings after the parameter value VAL is changed from the value i_{A} to the value i_{B} at which the value of the output modulation signal Smd matches the intermediate value Din_mid during the increase or decrease process of the value of the output modulation signal Smd, or a timing at which the value of the output modulation signal Smd changes from a state smaller than the intermediate value Din_mid to a state larger than the intermediate value Din_mid during the increase process of the value of the output modulation signal Smd, or a timing at which the value of the output modulation signal Smd changes from a state larger than the intermediate value Din_mid to a state smaller than the intermediate value Din_mid during the decrease process of the value of the output modulation signal Smd.

A more specific illustration is given with reference to the example of FIG. 7. Before time t_{A2}, the signal generation unit operation is repeatedly executed in a state where the modulation signal Smd[0] is set as the output modulation signal Smd. At time t_{A2}, the value of the output modulation signal Smd is in the decrease process and the value of the output modulation signal Smd is greater than the intermediate value Din_mid. Since the parameter value VAL switches from “0” to “3” at time t_{A2}, a read command signal is output from the holding circuit 113 to the signal generation circuit 114. In response to receiving the read command signal, after a slight time has passed from time t_{A2}, the signal generation circuit 114 reads the latest parameter value VAL held in the holding circuit 113 (assuming the reading time is before time t_{A3}). The parameter value VAL read corresponding to a transmission and reception of the read command signal at time t_{A2} is “3.” After time t_{A2}, the value of the output modulation signal Smd decreases, and at time t_{A3}, the value of the output modulation signal Smd matches the intermediate value Din_mid, so time t_{A3} is set as a waveform update timing by the signal generation circuit 114. At the first waveform update timing, which is time t_{A3}, the signal generation circuit 114 switches the output modulation signal Smd from the modulation signal Smd[0] to the modulation signal Smd[3]. Therefore, from time t_{A3}, the signal generation unit operation is started in which the modulation signal Smd[3] is set as the output modulation signal Smd. Consequently, after time t_{A3}, the value of the output modulation signal Smd changes according to characteristics of the modulation signal Smd[3]. In the example of FIG. 7, from time t_{A3}, the value of the output modulation signal Smd increases from the intermediate value Din_mid according to the characteristics of the modulation signal Smd[3]. That is, a change direction of the output modulation signal Smd reverses at time t_{A3}. However, this reversal is not necessary, and as a modification, the value of the output modulation signal Smd may decrease from the intermediate value Din_mid according to the characteristics of the modulation signal Smd[3] from time t_{A3}.

After time t_{A3}, at least until time t_{A12}, the signal generation unit operation is repeatedly executed in a state where the modulation signal Smd[3] is set as the output modulation signal Smd. At time t_{A12}, the value of the output modulation signal Smd is in the increasing process and is smaller than the intermediate value Din_mid. Since the parameter value VAL switches from “3” to “11” at time t_{A12}, a read command signal is output from the holding circuit 113 to the signal generation circuit 114. In response to receiving the read command signal, after a slight time has passed from time t_{A12}, the signal generation circuit 114 reads the latest parameter value VAL held in the holding circuit 113 (assuming the reading time is before time t_{A13}). The parameter value VAL read corresponding to the transmission and reception of the read command signal at time t_{A12} is “11.” After time t_{A12}, the value of the output modulation signal Smd increases, and at time t_{A13}, the value of the output modulation signal Smd matches the intermediate value Din_mid, so time t_{A13} is set as the waveform update timing by the signal generation circuit 114. At a second waveform update timing, which is time t_{A13}, the signal generation circuit 114 switches the output modulation signal Smd from the modulation signal Smd[3] to the modulation signal Smd[11]. Therefore, from time t_{A13}, the signal generation unit operation is started in which the modulation signal Smd[11] is set as the output modulation signal Smd. Consequently, after time t_{A13}, the value of the output modulation signal Smd changes according to characteristics of the modulation signal Smd[11]. In the example of FIG. 7, from time t_{A13}, the value of the output modulation signal Smd decreases from the intermediate value Din_mid according to the characteristics of the modulation signal Smd[11]. That is, the change direction of the output modulation signal Smd reverses at time t_{A13}. However, this reversal is not necessary, and as a modification, the value of the output modulation signal Smd may increase from the intermediate value Din_mid according to the characteristics of the modulation signal Smd[11] from time t_{A13}.

Furthermore, regardless of the value of the output modulation signal Smd at a time when the signal generation circuit 114 receives the read command signal, the signal generation circuit 114 may immediately switch the output modulation signal Smd in response to receiving the read command signal. That is, the signal generation circuit 114 may switch the output modulation signal Smd from the modulation signal Smd[0] to the modulation signal Smd[3] after time t_{A2} and before reaching time t_{A3}, and similarly, may switch the output modulation signal Smd from the

modulation signal Smd[3] to the modulation signal Smd[11] after time t_{A12} and before reaching time t_{A13}. In this case, a value of the output modulation signal Smd immediately after the output modulation signal Smd is switched from the modulation signal Smd[0] to the modulation signal Smd[3] and a value of the output modulation signal Smd immediately after the output modulation

signal Smd is switched from the modulation signal Smd[3] to the modulation signal Smd[11] may be the intermediate value Din_mid.

As such, in the switching power supply device 1 of FIG. 1, the frequency of the target clock signal CLK2 is spread by the modulation signal Smd (output modulation signal Smd) having characteristics corresponding to the parameter value VAL. Since the timing (sampling timing) for acquiring the parameter value VAL from the counter 111 is set depending on a signal asynchronous to the internal clock signal CLK1, the parameter value VAL becomes random at each sampling timing. Consequently, the output modulation signal Smd from the signal generation circuit 114 becomes a triangular wave signal having random characteristics at each sampling timing. As a result, reduction of a peak in a power spectrum of a radiated noise from the switching power supply device 1 can be suppressed. In the switching power supply device 1200 of FIG. 22, a large peak occurs in a radiated noise at a frequency of the triangular wave signal 1212 and a harmonic frequency of the triangular wave signal 1212, whereas in the switching power supply device 1, the frequency of the triangular wave changes randomly, and therefore the peak value of the radiated noise being suppressed more than in the switching power supply device 1200 of FIG. 22 becomes possible. This leads to improved EMI characteristics.

Hereinafter, several specific configuration examples, application technologies, modification techniques, etc., related to the switching power supply device 1 are illustrated in multiple embodiments. Matters described above in this embodiment regarding the switching power supply device 1 are applied to each of the following embodiments unless otherwise specified and unless there is a contradiction. In each embodiment, when there are matters that contradict the above matters, the description in each embodiment may take precedence. Additionally, unless there is a contradiction, matters described in any of the following embodiments can be applied to any of the other embodiment (i.e., it is possible to combine any two or more of the multiple embodiments).

### First Embodiment

A first embodiment is illustrated. As mentioned above, in the switching power supply device 1, the frequency of the triangular wave changes randomly, and therefore the peak value of radiated noise being suppressed more than the switching power supply device 1200 in FIG. 22 becomes possible. From this perspective, the signal generation circuit 114 may variably set only the frequency according to the parameter value VAL among the frequency and amplitude of the output modulation signal Smd. In this case, it is sufficient if amplitudes of the modulation signals Smd[0] to Smd[15] are set to be equal to each other (i.e., amplitudes Amd[0] to Amd[15] are set to be equal to each other) while frequencies of the modulation signals Smd[0] to Smd[15] are made different from each other (i.e., frequencies fmd[0] to fmd[15] are made different from each other). As a result, an effect of suppressing the peak value of radiated noise is expected to be sufficient as well.

### Second Embodiment

A second embodiment is illustrated. The signal generation circuit 114 may variably set only the amplitude according to the parameter value VAL among the frequency and amplitude of the output modulation signal Smd. In this case, it is sufficient if frequencies of the modulation signals Smd[0] to Smd[15] are set to be equal to each other (i.e., frequencies fmd[0] to fmd[15] are set to be equal to each other) while amplitudes of the modulation signals Smd[0] to Smd[15] are made different from each other (i.e., amplitudes Amd[0] to Amd[15] are made different from each other).

In this case, since the frequency of the triangular wave as the output modulation signal Smd is constant, a large peak in radiated noise is likely to occur at the frequency of the triangular wave and the harmonic frequency of the triangular wave. However, the amplitude of the output modulation signal Smd varies randomly, and therefore the appearance of the peak in radiated noise varies over time compared to the case where the amplitude of the output modulation signal Smd is fixed (and thus compared to the switching power supply device 1200 in FIG. 22). Therefore, the peak value on a power spectrum of the radiated noise obtained by setting a certain time as a window function reduced to some extend becomes possible. However, the peak reduction effect of radiated noise by the technology of the present disclosure is mainly achieved by randomly varying the frequency of the output modulation signal Smd (the frequency of the triangular wave), so it is desirable to variably set at least the frequency of the output modulation signal Smd according to the parameter value VAL.

### Third Embodiment

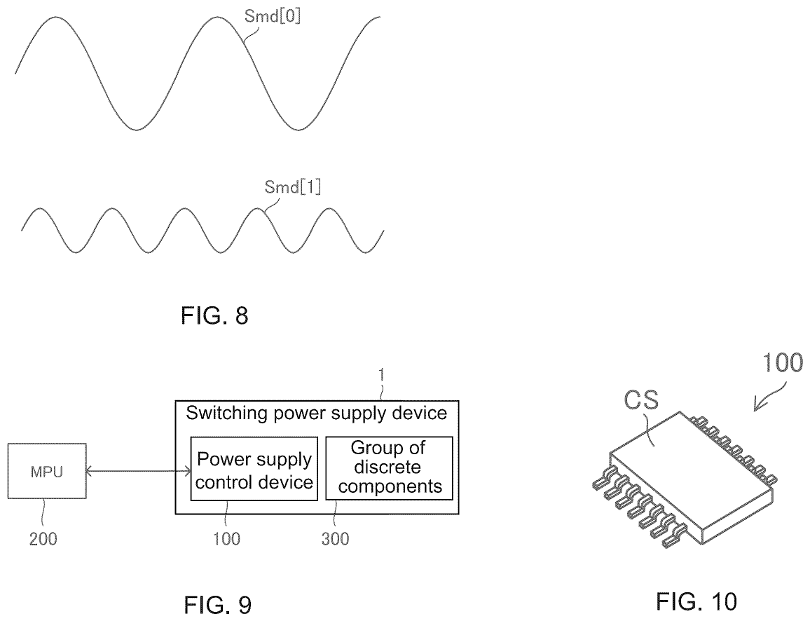

A third embodiment is illustrated. Up to this point, it has been assumed that the modulation signals Smd[0] to Smd[15] are triangular wave signals (i.e., it has been assumed that waveform shapes of the modulation signals Smd[0] to Smd[15] are triangular waves). Nevertheless, the modulation signals Smd[0] to Smd[15] may be any pulsating signals comprising any waveform shape. That is, for example, each of the modulation signals Smd[0] to Smd[15] may be a sine wave signal having a sine wave waveform shape, may be a pseudo-sine wave signal having a waveform shape approximating a sine wave waveform shape, or may be a mixed signal obtained by mixing a triangular wave signal and a sine wave signal. FIG. 8 shows modulation signals Smd[0] and Smd[1] each having a sine wave waveform shape. In the example of FIG. 8, a frequency and an amplitude of the sine wave signal as the modulation signal Smd[0] differ from a frequency and an amplitude of the sine wave signal as the modulation signal Smd[1]. The same applies to the modulation signals Smd[2] to Smd[15].

Furthermore, among the modulation signals Smd[0] to Smd[15], modulation signals having a triangular wave waveform shape, modulation signals having a sine wave waveform shape, modulation signals having a pseudo-sine wave waveform shape, and modulation signals corresponding to the above mixed signals may coexist.

### Fourth Embodiment

A fourth embodiment is illustrated. FIG. 9 shows a configuration of a system SYS according to the fourth embodiment. The system SYS comprises a switching power supply device 1 and an MPU (Micro Processing Unit) 200. The switching power supply device 1 comprises a power supply control device 100 and a group of discrete components 300. The group of discrete components 300 is formed of multiple discrete components externally connected to the power supply control device 100. The MPU 200 is an example of an external device provided outside the power supply control device 100. The MPU 200 is connected to the power supply control device 100.

FIG. 10 shows an external perspective view of the power supply control device 100. The power supply control device 100 is an electronic component comprising a semiconductor chip that comprises a semiconductor integrated circuit formed on a semiconductor substrate, a housing CS (package) that accommodates the semiconductor chip, and multiple external terminals that are exposed to an outside of the power supply control device 100 from the housing CS. The power supply control device 100 is formed by encapsulating the semiconductor chip within the housing CS made of resin. Furthermore, a number of the external terminals of the power supply control device 100 and a type of the housing CS shown in FIG. 10 are merely examples, and these can be designed arbitrarily. The system SYS can be referred to as a power supply system. Considering that the power supply control device 100 is a semiconductor device, the system SYS can be referred to as a semiconductor system.

The above clock signal generation circuit 10 and switching controller 21 (refer to FIG. 1) are provided within the power supply control device 100. A part of the power conversion circuit 22 (such as output transistors) is provided within the power supply control device 100, and the remaining part of the power conversion circuit 22 is formed by the group of discrete components 300.

FIG. 11 shows a configuration of the switching power supply device 1 according to the fourth embodiment. The switching power supply device 1 of FIG. 11 comprises the power supply control device 100 and also comprises, as components of the group of discrete components 300, a coil L1, an output capacitor C1, and feedback resistors R1 and R2. In the configuration of FIG. 11, the power conversion circuit 22 (refer to FIG. 1) is configured with an output stage circuit MM, the coil L1, the output capacitor C1, and the feedback resistors R1 and R2. The switching power supply device 1 in FIG. 11 is configured as a step-down switching power supply device (DC/DC converter) that generates a desired output voltage Vout from an input voltage Vin supplied from a DC voltage source which is not shown. The output voltage Vout is generated at an output terminal OUT. That is, the output terminal OUT is an application terminal of the output voltage Vout (a terminal to which the output voltage Vout is applied). The output voltage Vout is supplied to a load LD connected to the output terminal OUT.

Except for transient states, the input voltage Vin and the output voltage Vout are positive direct current voltages, and the output voltage Vout is lower than the input voltage Vin. For example, when the input voltage Vin is 12 V, the output voltage Vout can be stabilized at a desired positive voltage value below 12 V (such as 3.3 V or 5 V) by adjusting resistance values of the feedback resistors R1 and R2.

FIG. 11 shows, as a part of a group of external terminals provided in the power supply control device 100, an input terminal IN, a switch terminal SW, a ground terminal GND, and a feedback terminal FB.

An external configuration of the power supply control device 100 is illustrated. The input voltage Vin is supplied to the input terminal IN from a direct current voltage source (not shown) provided outside the power supply control device 100. The coil L1 is interposed in series between the switch terminal SW and the output terminal OUT. That is, a first end of the coil L1 is connected to the switch terminal SW, and a second end of the coil L1 is connected to the output terminal OUT. Additionally, the output terminal OUT is connected to a ground via an output capacitor C1. That is, a first end of the output capacitor C1 is connected to the output terminal OUT, and a second end of the output capacitor C1 is connected to the ground. Moreover, the output terminal OUT is connected to a first end of the feedback resistor R1, a second end of the feedback resistor R1 is connected to a first end of the feedback resistor R2, and a second end of the feedback resistor R2 is connected to the ground. A feedback voltage Vfb is generated at a connection node between the feedback resistors R1 and R2. The connection node between the feedback resistors R1 and R2 is connected to the feedback terminal FB, thereby inputting the feedback voltage Vfb to the feedback terminal FB. The ground terminal GND is connected to the ground.

An internal configuration of the power supply control device 100 is illustrated. The power supply control device 100 comprises an output stage circuit MM, a switching controller 21, and a clock signal generation circuit 10.

The output stage circuit MM comprises transistors MH and ML. In the configuration example of FIG. 11, the transistors MH and ML are formed of N-channel MOSFETs. The transistors MH and ML are a pair of switching elements connected in series between an input terminal IN and a ground terminal GND (in other words, the ground). The transistor MH functions as an output element (output transistor), and the transistor ML functions as a rectifying element (synchronous rectification transistor). The transistor MH is provided on a higher-potential side than the transistor ML. Specifically, a drain of the transistor MH is connected to the input terminal IN, which is an application terminal of the input voltage Vin, to receive a supply of the input voltage Vin. A source of the transistor MH and a drain of the transistor ML are commonly connected to a switch terminal SW. A source of the transistor ML is connected to the ground terminal GND (and thus connected to the ground). However, a current detection resistor may be inserted between the source of the transistor ML and the ground terminal GND.

The switching of the output stage circuit MM is controlled by the switching controller 21. In the switching control of the output stage circuit MM, the transistors MH and ML are switched so that the transistors MH and ML are alternately turned on and off. A rectangular wave-shaped switch voltage Vsw appears at the switch terminal SW due to the switching control of the output stage circuit MM. The coil L1 and the output capacitor C1 form a rectifying and smoothing circuit that rectifies and smooths the rectangular wave-shaped switch voltage Vsw appearing at the switch terminal SW to generate the output voltage Vout. The feedback resistors R1 and R2 form a feedback voltage generation circuit that generates a feedback voltage Vfb corresponding to the output voltage Vout by dividing the output voltage Vout. The feedback voltage Vfb is proportional to the output voltage Vout, and rises or falls with a rise or fall of the output voltage Vout.

Furthermore, a modification may be made to use the output voltage Vout itself as the feedback voltage Vfb. In any case, the feedback voltage Vfb is a voltage corresponding to the output voltage Vout. Additionally, the feedback voltage generation circuit (R1, R2) may be provided within the power supply control device 100, in which case the feedback terminal FB is connected to the output terminal OUT.

Gate signals GH and GL are supplied as drive signals to gates of transistors MH and ML, respectively, and the transistors MH and ML are turned on and off according to the gate signals GH and GL. During a high-level period of the gate signal GH, the transistor MH is in an on state, and during a low-level period of the gate signal GH, the transistor MH is in an off state. Similarly, during a high-level period of the gate signal GL, the transistor ML is in an on state, and during a low-level period of the gate signal GL, the transistor ML is in an off state.

Basically, the transistors MH and ML are alternately turned on and off, but sometimes both transistors MH and ML are maintained in the off state. That is, a state of the output stage circuit MM may be one of an output high state, output low state, or both-off state. In the output high state, the transistor MH is in the on state and the transistor ML is in the off state. In the output low state, the transistor MH is in the off state and the transistor ML is in the on state. In the both-off state, the transistors MH and ML are both in the off state. The transistors MH and ML are never simultaneously in the on state. In the switching control by the switching controller 21, alternating turning on and off the transistors M1 and M2 is a concept including a both-off state interposed, considering dead time, etc., in a transition between the output low state and the output high state. Furthermore, at least one of the transistors MH and ML may be provided outside the power supply control device 100. The entire output stage circuit MM may be provided outside the power supply control device 100.

The switching controller 21 is connected to the feedback terminal FB and receives the feedback voltage Vfb. The switching controller 21 controls the on/off states of each of the transistors MH and ML through level control of the gate signals GH and GL based on the feedback voltage Vfb, thereby generating a desired output voltage Vout at the output terminal OUT. A reference voltage Vref having a predetermined positive direct current voltage value is generated within the power supply control device 100, and the switching controller 21 adjusts an output duty of the output stage circuit MM using a pulse-width modulation method so that the feedback voltage Vfb matches the reference voltage Vref. The output duty represents a ratio of a period during which the output stage circuit MM is in the output high state to a sum of a period during which the output stage circuit MM is in the output high state and a period during which the output stage circuit MM is in the output low state.

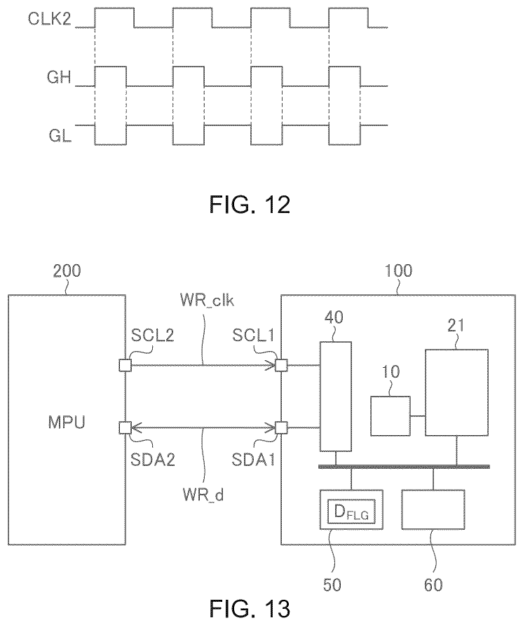

The switching controller 21 determines a switching frequency of the transistors MH and ML based on a target clock signal CLK2 output from the clock signal generation circuit 10. Specifically, as shown in FIG. 12, the switching controller 21 performs a unit operation that switches the state of the output stage circuit MM from the output low state to the output high state at the timing at which a rising edge occurs in the target clock signal CLK2, and then switches the state of the output stage circuit MM from the output high state to the output low state based on another signal (not shown). This unit operation is repeated in the switching control. The switching controller 21 controls the output duty by generating the other signal mentioned above so that an error between the feedback voltage Vfb and the reference voltage Vref approaches zero. Furthermore, the duty of the target clock signal CLK2 is arbitrary.

Each time a rising edge occurs in the target clock signal CLK2, the transistor MH (output transistor) is switched from the off state to the on state, so a switching frequency of the transistor MH matches a frequency f_{CLK2}. As described above, the frequency f_{CLK2} represents the frequency of the target clock signal CLK2. However, within the power supply control device 100, a frequency-divided clock signal may be generated by dividing the target clock signal CLK2 by m, and the state of the output stage circuit MM may be switched from the output low state to the output high state at a timing at which a rising edge occurs in this frequency-divided clock signal (m represents any integer of 2 or more). In this case, each time a rising edge occurs in the frequency-divided clock signal, the transistor MH (output transistor) is switched from the off state to the on state, so the switching frequency of the transistor MH becomes 1/m times the frequency f_{CLK2}. In any case, the transistor MH is switched at a switching frequency proportional to the frequency f_{CLK2}.

Furthermore, although not specifically shown, the power supply control device 100 is provided with an internal power supply circuit that generates an internal power supply voltage based on the input voltage Vin. Each circuit within the power supply control device 100 is driven based on the input voltage Vin or the internal power supply voltage. Additionally, while the gate signal GL is a signal based on a ground potential, the gate signal GH is a signal based on a potential of the switch terminal SW. The low-level gate signal GH has a potential of the switch terminal SW, and the high-level gate signal GH is higher by a predetermined voltage viewed from the potential of the switch terminal SW. The predetermined voltage here is greater than a gate threshold voltage of the transistor MH. A boost power supply for generating the gate signal GH can be generated using a well-known bootstrap circuit (not shown). The transistor MH may be configured as a P-channel MOSFET, in which case the boost power supply is unnecessary.

Additionally, as a modification, a diode rectification method may be adopted in the switching power supply device 1. In this case, as a rectifying element, instead of the transistor ML, a synchronous rectification diode comprising an anode connected to the ground terminal GND and a cathode connected to the switch terminal SW is provided in the switching power supply device 1. In this case, only the transistor MH is turned on and off in the switching control of the output stage circuit MM. In any case, the input voltage Vin is converted to the output voltage Vout through the switching of the transistor MH between the on and off states in the switching control of the output stage circuit MM.

The power supply control device 100 and the MPU 200 are connected in a manner that allows bidirectional communication. The communication between the power supply control device 100 and the MPU 200 may be serial communication, and each of the power supply control device 100 and the MPU 200 is provided with a group of communication terminals for realizing serial communication. Herein, it is assumed that an interface by I²C (Inter-Integrated Circuit) is used as an interface of serial communication. Then, as shown in FIG. 13, the group of communication terminals provided in the power supply control device 100 includes terminals SCL1 and SDA1, and the group of communication terminals provided in the MPU 200 includes terminals SCL2 and SDA2. The terminals SCL1 and SDA1 are two external terminals provided in the power supply control device 100. The MPU 200 comprises external terminals similar to the power supply control device 100, and the terminals SCL2 and SDA2 are two external terminals provided in the MPU 200. The terminal SCL1 of the power supply control device 100 is connected to the terminal SCL2 of the MPU 200 via a clock wiring WR_clk, and the terminal SDA1 of the power supply control device 100 is connected to the terminal SDA2 of the MPU 200 via a data wiring WR_d.

The MPU 200 outputs a clock signal for communication from the terminal SCL2, and the clock signal for communication is received at the terminal SCL1 of the power supply control device 100. Each of the data terminals SDA1 and SDA2 sometimes functions as a data output terminal that outputs data signals to the data wiring WR_d, and sometimes functions as a data input terminal that receives data signals transmitted on the data wiring WR_d. A device that outputs a data signal to the data wiring WR_d is referred to as a transmitter, and a device that receives a data signal transmitted on the data wiring WR_d is referred to as a receiver. The device here is either the power supply control device 100 or the MPU 200. According to the I²C specification, at any given time, only one of the devices connected to the data wiring WR_d can be the transmitter.

The MPU 200 can send multiple types of commands to the power supply control device 100. A signal representing a command is specifically referred to as a command signal. By outputting a command signal representing any command from the data terminal SDA2 while outputting a clock signal for communication from the clock terminal SCL2 according to a predetermined protocol, the MPU 200 can send this command to the power supply control device 100. By receiving the command signal representing a command at the data terminal SDA1 while receiving the clock signal for communication at the clock terminal SCL1 according to the above protocol, the power supply control device 100 receives this command. The above protocol is both a communication protocol defined by I²C and a communication protocol established between the power supply control device 100 and the MPU 200.

The power supply control device 100 is provided with an interface circuit 40 connected to the terminals SCL1 and SDA1 (refer to FIG. 13). The interface circuit 40 decodes the command signal received from the MPU 200 and executes the processing required by this command signal.

Additionally, the power supply control device 100 is provided with a memory 50 where a memory space is defined. The memory 50 comprises multiple storage areas to which multiple addresses are assigned. A flag data D_{FLG}, which is a 1-bit data, is stored in a storage area assigned to a specific address among the multiple addresses. The flag data D_{FLG} comprises a value of “0” or “1.” An initial value of the flag data D_{FLG} is “0.”

Commands that the MPU 200 can send to the power supply control device 100 include a write command and a read command. The write command is a command that instructs writing target data to a storage area assigned to a write target address within the memory 50. The command signal representing the write command includes information indicating the write target address and the write target data. The read command is a command that instructs reading stored data from a storage area assigned to a read target address within the memory 50 and sending it to the MPU 200. The command signal representing the read command includes information indicating the read target address.

The command signal is an example of a communication signal sent by the MPU 200 and received by the power supply control device 100. In the fourth embodiment, the communication signal between the MPU 200 and the power supply control device 100 is used as the above asynchronous signal AS. The communication signal used as the asynchronous signal AS needs to be repeatedly sent from the MPU 200 to the power supply control device 100, independently of the internal clock signal CLK1. Command signals for a watchdog timer as command signals that meet such requirements are listed below.

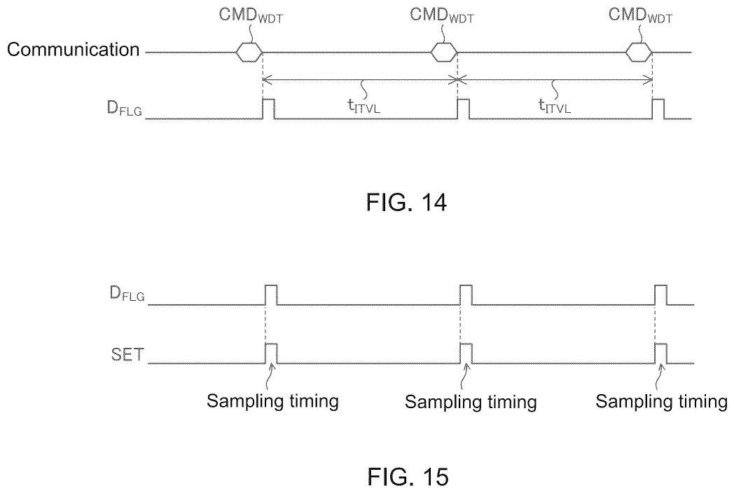

The monitoring circuit 60 provided in the power supply control device 100 monitors a presence or absence of an abnormality in the MPU 200. The monitoring circuit 60 forms a watchdog timer using the flag data D_{FLG}. The watchdog timer by the monitoring circuit 60 is illustrated with reference to FIG. 14. In the system SYS of FIG. 9, after a startup of the power supply control device 100 and the MPU 200, it is determined that the MPU 200 periodically sends a write command for the watchdog timer (hereinafter referred to as a write command CMD_{WDT}) to the power supply control device 100. The write target address in the write command CMD_{WDT} is an address of a storage area storing the flag data D_{FLG}, and a write target data in the write command CMD_{WDT} is “1.” Thus, when the write command CMD_{WDT} is received by the power supply control device 100, “1” is written to the flag data D_{FLG} by the interface circuit 40 in accordance with the write command CMD_{WDT}.

The monitoring circuit 60 monitors whether “1” is written to the flag data D_{FLG}. The monitoring circuit 60 may monitor whether the write command CMD_{WDT} is received by the power supply control device 100. When a value of the flag data D_{FLG} switches from “0” to “1,” the monitoring circuit 60 immediately returns the value of the flag data D_{FLG} to “0.” Therefore, each time the write command CMD_{WDT} is received by the power supply control device 100, the value of the flag data D_{FLG} switches from “0” to “1” and is immediately returned to “0.”

The monitoring circuit 60 comprises a timer for monitoring a state of the MPU 200 and measures a reception interval t_{ITVL} of the write command CMD_{WDT} in the power supply control device 100 using this timer. The reception interval t_{ITVL} of the write command CMD_{WDT} in the power supply control device 100 is equivalent to a transmission interval of the write command CMD_{WDT} by the MPU 200. The monitoring circuit 60 measures a time from when the value of the flag data D_{FLG} is switched from “0” to “1” to the next time the value of the flag data D_{FLG} is switched from “0” to “1” as the reception interval t_{ITVL} of the write command CMD_{WDT}. Since the write command CMD_{WDT} is repeatedly sent from the MPU 200 to the power supply control device 100, the reception interval t_{ITVL} is defined for each combination of reception of two adjacent write commands CMD_{WDT}.

When the MPU 200 is operating normally, the MPU 200 repeatedly sends the write command CMD_{WDT} to the power supply control device 100 so that the transmission interval of the write command CMD_{WDT} falls within a predetermined time range t_{RNG}. The time range t_{RNG} is a range equal to or greater than a predetermined lower limit time t_{LIM1} (e.g., 0.8 milliseconds) and equal to or less than a predetermined upper limit time t_{LIM2} (e.g., 1.2 milliseconds). “0<t_{LM1}<t_{LIM2}” is satisfied. The monitoring circuit 60 measures the reception interval t_{ITVL} of the write command CMD_{WDT}, and monitors the presence or absence of an abnormality in the MPU 200 based on the measurement results.

When the reception interval t_{ITVL} of the write command CMD_{WDT} falls within the time range t_{RNG}, the monitoring circuit 60 determines that the MPU 200 is normal (there is no abnormality in the MPU 200). That is, when a time from when the value of the flag data D_{FLG} is switched from “0” to “1” until the value of the flag data D_{FLG} is next switched from “0” to “1” falls within the time range t_{RNG}, the monitoring circuit 60 determines that the MPU 200 is normal (there is no abnormality in the MPU 200).

When the reception interval t_{ITVL} of the write command CMD_{WDT} deviates from the time range t_{RNG}, the monitoring circuit 60 determines that there is an abnormality in the MPU 200. That is, when a time from when the value of the flag data D_{FLG} is switched from “0” to “1” to the next time the value of the flag data D_{FLG} is switched from “0” to “1” is less than the lower limit time t_{LIM1}, the monitoring circuit 60 determines that there is an abnormality in the MPU 200. Alternatively, when the value of the flag data D_{FLG} is not switched from “0” to “1” again even after the upper limit time t_{LIM2} has elapsed since the flag data D_{FLG} is switched from “0” to “1,” the monitoring circuit 60 considers the reception of the write command CMD_{WDT} to be ceased and determines that there is an abnormality in the MPU 200.

When the monitoring circuit 60 determines that there is an abnormality in the MPU 200, it sends a predetermined error signal from an error output terminal (one of the external terminals) provided in the power supply control device 100. The error signal is transmitted to a device (MPU 200 or another device) provided outside the power supply control device 100. Additionally, when it is determined that there is an abnormality in the MPU 200 by the monitoring circuit 60, the switching controller 210 may stop the switching control over the output stage circuit MM, and thereafter it may keep the transistors MH and ML off unless a predetermined release condition is met (for example, unless the power supply to the power supply control device 100 is reconnected).

To use the communication signal between the MPU 200 and the power supply control device 100 as the asynchronous signal AS, the following may be specifically employed. Referring again to FIGS. 1 and 3, the timing setting circuit 112 sets the sampling timing based on a timing at which the write command CMD_{WDT} is received by the power supply control device 100 (in other words, a timing at which it is received by the interface circuit 40). For example, the timing setting circuit 112 may generate a rising edge in the signal SET at a timing at which the value of the flag data D_{FLG} changes from “0” to “1,” as shown in FIG. 15. Alternatively, for example, the timing setting circuit 112 may generate a rising edge in the signal SET at a timing at which a rising edge occurs in the internal clock signal CLK1 after the value of the flag data D_{FLG} changes from “0” to “1.” Furthermore, the writing operation for the value of the flag data D_{FLG} may be executed in synchronization with the internal clock signal CLK1.

Since the write command CMD_{WDT} is repeatedly sent from the MPU 200 to the power supply control device 100, the sampling timing is set by the timing setting circuit 112 each time the write command CMD_{WDT} is received by the power supply control device 100 (i.e., a pulse is generated in the signal SET), and the parameter value VAL is updated with the latest count value CNT at each sampling timing by the holding circuit 113 (refer to FIG. 3).

Furthermore, although the configuration and operation when using I²C as the interface for serial communication between the power supply control device 100 and the MPU 200 are described above, this interface is not limited to I²C. For example, an interface using SPI (Serial Peripheral Interface) or Microwire may be used as the interface for serial communication between the power supply control device 100 and MPU 200.

### Fifth Embodiment

A fifth embodiment is illustrated. In the fifth embodiment, the sampling timing is set without using communication with an external device (MPU 200). The system according to the fifth embodiment has the same configuration as the system SYS according to the fourth embodiment (refer to FIG. 9), and except for the method of setting the sampling timing, the matters shown in the fourth embodiment are also applicable to the fifth embodiment. Regardless of communication with the MPU 200, any signal generated within the power supply control device 100 (particularly, for example, within the clock signal generation circuit 10) and asynchronous with the internal clock signal CLK1 may be used as the asynchronous signal AS to set the sampling timing.

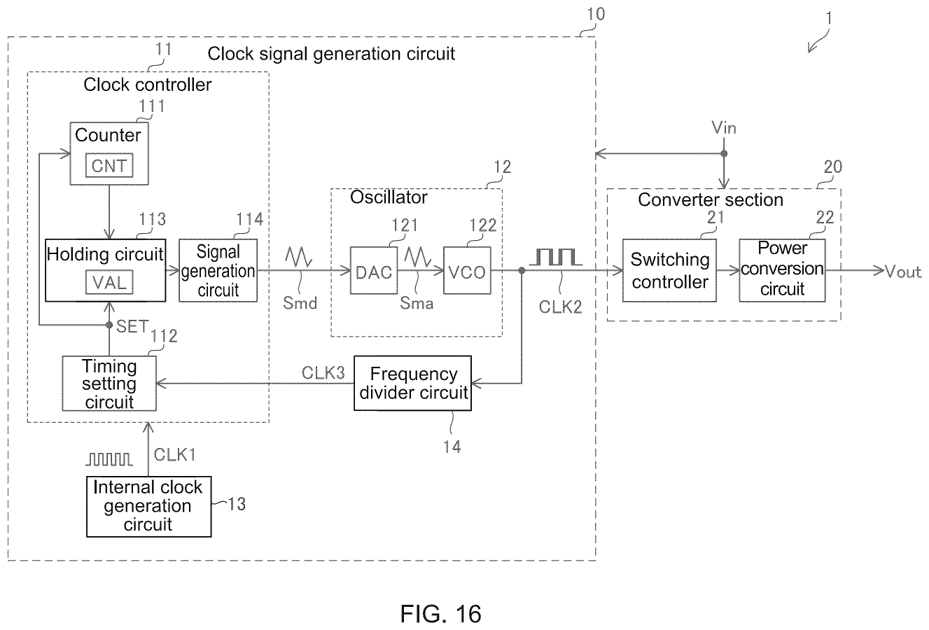

For example, the asynchronous signal AS can be obtained by dividing the target clock signal CLK2. This is illustrated in detail. FIG. 16 is a schematic overall configuration diagram of the switching power supply device 1 according to the fifth embodiment. In the fifth embodiment, a frequency divider circuit 14 is added to the switching power supply device 1 shown in FIG. 1. The frequency divider circuit 14 is provided within the clock signal generation circuit 10. The target clock signal CLK2 is input to the frequency divider circuit 14. The frequency divider circuit 14 generates a frequency-divided clock signal CLK3 by dividing the target clock signal CLK2 by n. That is, the frequency-divided clock signal CLK3 is a rectangular wave signal alternating between a high level and a low level, and a frequency of the frequency-divided clock signal CLK3 is 1/n times a frequency f_{CLK2} of the target clock signal CLK2, and n is any integer of 2 or more and may usually be much larger than 2. The frequency of the frequency-divided clock signal CLK3 is hereinafter referred to as a frequency f_{CLK3}.

The target clock signal CLK2 is a signal generated by a VCO 122, which includes an analog circuit, and is asynchronous with the internal clock signal CLK1. Therefore, the frequency-divided clock signal CLK3 is also asynchronous with the target clock signal CLK2. The timing setting circuit 112 according to the fifth embodiment uses the frequency-divided clock signal CLK3 as an asynchronous signal AS, and consequently sets the sampling timing based on the frequency-divided clock signal CLK3 (generating a pulse of the signal SET).

As a method for setting the sampling timing based on the frequency-divided clock signal CLK3, first to fourth setting methods are listed below. The timing setting circuit 112 can adopt any of the first to fourth setting methods.

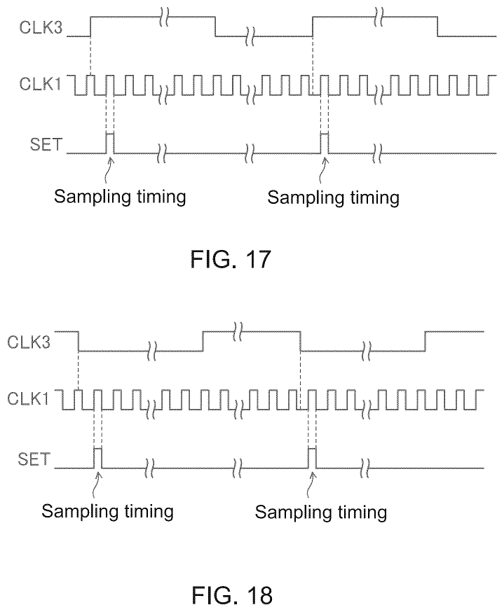

In the first setting method, the timing setting circuit 112 monitors an occurrence of the rising edge in the frequency-divided clock signal CLK3. Then, as shown in FIG. 17, after a rising edge occurs in the frequency-divided clock signal CLK3, the timing setting circuit 112 according to the first setting method generates a rising edge in the signal SET at a timing of the next rising edge of the internal clock signal CLK1. Consequently, in the first setting method, the sampling timing is set based on a timing at which a level of the frequency-divided clock signal CLK3 changes from a low level to a high level. As described above, the length of a high-level period of the signal SET is equal to the length of one period of the internal clock signal CLK1. Therefore, after generating a rising edge in the signal SET, the timing setting circuit 112 generates a falling edge in the signal SET synchronized with the next rising edge of the internal clock signal CLK1 (similarly in the second to fourth setting methods described later).

In the second setting method, the timing setting circuit 112 monitors an occurrence of a falling edge in the frequency-divided clock signal CLK3. Then, as shown in FIG. 18, after a falling edge occurs in the frequency-divided clock signal CLK3, the timing setting circuit 112 according to the second setting method generates a rising edge in the signal SET at the timing of the next rising edge of the internal clock signal CLK1. Consequently, in the second setting method, the sampling timing is set based on a timing at which a level of the frequency-divided clock signal CLK3 changes from a high level to a low level.

The rising edge and the falling edge of the frequency-divided clock signal CLK3 occur repeatedly. Therefore, in the first setting method, the sampling timing is set by the timing setting circuit 112 each time a rising edge occurs in the frequency-divided clock signal CLK3 (i.e., a pulse is generated in the signal SET), and the parameter value VAL is updated with the count value CNT at each sampling timing by the holding circuit 113 (refer to FIG. 3). Similarly, in the second setting method, the sampling timing is set by the timing setting circuit 112 each time a falling edge occurs in the frequency-divided clock signal CLK3 (i.e., a pulse is generated in the signal SET), and the parameter value VAL is updated with the count value CNT at each sampling timing by the holding circuit 113 (refer to FIG. 3).

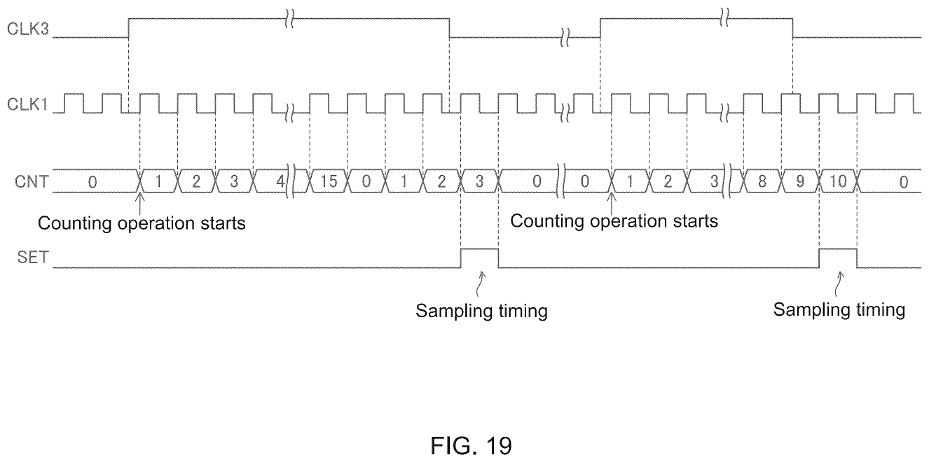

An outline of the third setting method is shown in FIG. 19. The third setting method is similar to the first setting method. However, while the counting operation by the counter 111 (i.e., an updating operation of the count value CNT) is always executed in the first setting method, in the third setting method, the counting operation by the counter 111 is executed only during the high-level period of the frequency-divided clock signal CLK3.

That is, the timing setting circuit 112 according to the third setting method monitors the occurrence of the rising edge in the frequency-divided clock signal CLK3, and when a rising edge occurs in the frequency-divided clock signal CLK3, starts the counting operation from the timing of the next rising edge of the internal clock signal CLK1. In the example of FIG. 19, the count value CNT is switched from “0” to “1” at a start of the counting operation, but the count value CNT may be switched from “0” to “1” at the timing of the next rising edge of the internal clock signal CLK1 after the start of the counting operation. After the counting operation is started, the timing setting circuit 112 monitors the occurrence of the falling edge in the frequency-divided clock signal CLK3, and after a falling edge occurs in the frequency-divided clock signal CLK3, generates a rising edge in the signal SET at the timing of the next rising edge of the internal clock signal CLK1. After the rising edge occurs in the signal SET, the count value CNT is reset at a timing at which the next rising edge of the internal clock signal CLK1 occurs, and thereafter, the counting operation stops.

As such, in the third setting method, the count value CNT is updated during a period from when a level of the frequency-divided clock signal CLK3 switches from the low level to the high level until it returns to the low level, and the timing setting circuit 112 sets the sampling timing based on a timing at which the level of the frequency-divided clock signal CLK3 returns to the low level during that period. When an overflow of the count value CNT in the counter 111 is ignored, in the third setting method, a length of the high-level period of the frequency-divided clock signal CLK3 is measured using the counter 111. In practice, the length of the high-level period of the frequency-divided clock signal CLK3 may be measured using the counter 111 and the sampling timing may be set based on the measurement result.

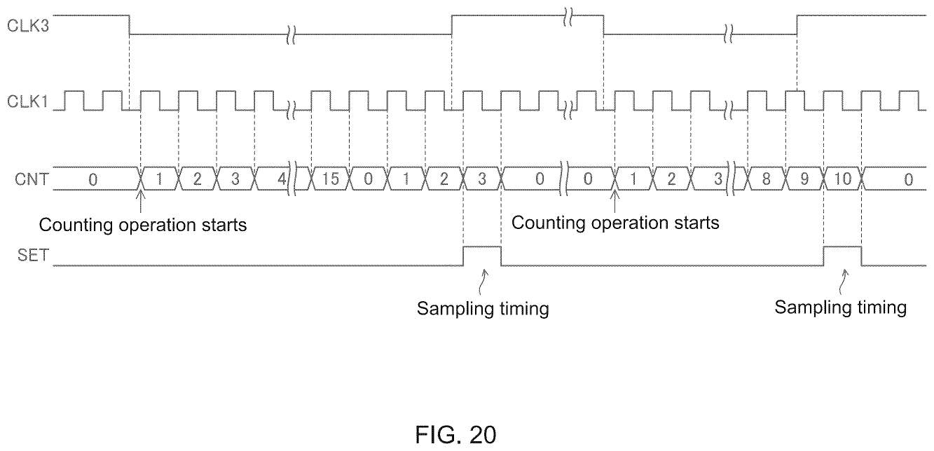

An outline of the fourth setting method is shown in FIG. 20. The fourth setting method is based on the third setting method, and a relationship between the high level and the low level of the frequency-divided clock signal CLK3 is reversed. Thus, the fourth setting method is similar to the second setting method. However, while the counting operation by the counter 111 (i.e., an updating operation of the count value CNT) is always executed in the second setting method, in the fourth setting method, the counting operation by the counter 111 is executed only during a low-level period of the frequency-divided clock signal CLK3.

That is, the timing setting circuit 112 according to the fourth setting method monitors an occurrence of the falling edge in the frequency-divided clock signal CLK3, and when a falling edge occurs in the frequency-divided clock signal CLK3, starts the counting operation from the timing of the next rising edge of the internal clock signal CLK1. In the example of FIG. 20, the count value CNT is switched from “0” to “1” at a start of the counting operation, but the count value CNT may be switched from “0” to “1” at the timing of the next rising edge of the internal clock signal CLK1 after the start of the counting operation. After the counting operation is started, the timing setting circuit 112 monitors the occurrence of the rising edge in the frequency-divided clock signal CLK3, and after a rising edge occurs in the frequency-divided clock signal CLK3, generates a rising edge in the signal SET at the timing of the next rising edge of the internal clock signal CLK1. After a rising edge occurs in the signal SET, the count value CNT is reset at the timing at which the next rising edge of the internal clock signal CLK1 occurs, and thereafter, the counting operation stops.

As such, in the fourth setting method, the count value CNT is updated during a period from when a level of the frequency-divided clock signal CLK3 switches from the high level to the low level until it returns to the high level, and the timing setting circuit 112 sets the sampling timing based on a timing at which the level of the frequency-divided clock signal CLK3 returns to the high level during that period. When an overflow of the count value CNT in the counter 111 is ignored, in the fourth setting method, a length of the low-level period of the frequency-divided clock signal CLK3 is measured using the counter 111. In practice, the length of the low-level period of the frequency-divided clock signal CLK3 may be measured using the counter 111 and the sampling timing may be set based on the measurement result.

The rising edge and the falling edge of the frequency-divided clock signal CLK3 occur repeatedly. Therefore, in the third and fourth setting methods, the sampling timing is set by the timing setting circuit 112 for each period of the frequency-divided clock signal CLK3 (i.e., a pulse is generated in the signal SET), and the parameter value VAL is updated with the count value CNT at each sampling timing by the holding circuit 113 (refer to FIG. 3).

### Sixth Embodiment

A sixth embodiment is illustrated. In FIG. 11, although an example is given where the switching power supply device 1 is a step-down type switching power supply device, the switching power supply device 1 may be a step-up type or a step-up/step-down type switching power supply device.

The switching power supply device 1 may be a composite power supply device incorporating multiple DC/DC converters. In this case, first to Kth DC/DC converters included in the multiple DC/DC converters may each be a step-down type DC/DC converter comprising a switching controller 21, an output stage circuit MM, a coil L1, an output capacitor C1, and feedback resistors R1 and R2 as shown in FIG. 11 (K is an integer of 2 or more). In this case, the switching controller 21 and the output stage circuit MM in each DC/DC converter are incorporated in the power supply control device 100 (however, each output stage circuit MM may be provided outside the power supply control device 100). When the switching power supply device 1 is a composite power supply device incorporating multiple DC/DC converters, the power supply control device 100 may be an electronic component classified as a PMIC (Power Management IC).

A single clock signal generation circuit 10 may be shared for the first to Kth DC/DC converters. In this case, within the power supply control device 100, it may be that first to Kth clock signals having different phases are generated from the target clock signal CLK2, and that the switching control of the output stage circuit MM of each of the first to Kth DC/DC converters is performed in synchronization with the first to Kth clock signals. Frequency of the first to Kth clock signals is equal to the frequency of the target clock signal CLK2. Alternatively, first to Kth clock signal generation circuits 10 corresponding to the first to Kth DC/DC converters may be provided in the power supply control device 100.

The multiple DC/DC converters incorporated in the composite power supply device may include a step-up type DC/DC converter. The composite power supply device may further comprise a linear regulator.

Additionally, the switching power supply device 1 may be an isolated type DC/DC converter comprising a transformer (not shown). In this case, the switching power supply device 1 comprises a primary side circuit and a secondary side circuit that are insulated from each other, the primary winding of the transformer is disposed in the primary side circuit, and the secondary winding is disposed in the secondary side circuit. Then, a voltage higher by the input voltage Vin viewed from a reference potential point of the primary side circuit is applied to a first end of the primary winding, and an output transistor is inserted between a second end of the primary winding and the reference potential point of the primary side circuit. When the switching power supply device 1 is an isolated type DC/DC converter comprising a transformer, it may be that a power conversion circuit 22 (refer to FIG. 1) is configured with an output transistor, a transformer, and a secondary side circuit, and that the switching controller 21 generates the output voltage Vout in the secondary side circuit by switching the output transistor in synchronization with the target clock signal CLK2.

### Seventh Embodiment

A seventh embodiment is illustrated.

The clock signal generation circuit 10 is not limited to the switching power supply device 1, and can be applied to any semiconductor device that requires a clock signal. Any semiconductor device that requires a clock signal comprises the clock signal generation circuit 10 and a synchronization circuit that operates in synchronization with the target clock signal CLK2. In the configuration of FIG. 11, the synchronization circuit includes the switching controller 21 and the output stage circuit MM.

For example, the first semiconductor device comprises the clock signal generation circuit 10, a half-bridge circuit, and a controller that switches the half-bridge circuit in synchronization with the target clock signal CLK2, and the synchronization circuit in the first semiconductor device includes the half-bridge circuit and the controller. Any load (for example, an armature winding of a motor) is connected to the half-bridge circuit of the first semiconductor device, and a current is supplied to the load through the half-bridge circuit. The half-bridge circuit in the first semiconductor device has the same configuration as the output stage circuit MM in FIG. 11, and the controller can switch the half-bridge circuit at the frequency of the target clock signal CLK2.

Alternatively, for example, a second semiconductor device comprises the clock signal generation circuit 10, U-phase, V-phase, and W-phase half-bridge circuits, and a controller that switches the half-bridge circuit of each phase in synchronization with the target clock signal CLK2, and the synchronization circuit in the second semiconductor device includes the half-bridge circuit of each phase and the controller. A three-phase motor is connected to the U-phase, V-phase, and W-phase half-bridge circuits in the second semiconductor device, and a current is supplied to the three-phase motor through the half-bridge circuit of each phase. The half-bridge circuit of each phase in the second semiconductor device has the same configuration as the output stage circuit MM in FIG. 11, and the controller can switch the half-bridge circuit of each phase at the frequency of the target clock signal CLK2.

Since either of the modulation signals Smd[0] to Smd[15] are selected as the output modulation signal Smd, it can be said that the modulation signals Smd[0] to Smd[15] are candidates for the output modulation signal Smd (a total of 16 types of candidates). In the above embodiment, it is assumed that “(Cmin, Cmax)=(0, 15)” (FIG. 2), and as a result, a total number of candidates for the output modulation signal Smd is 16, but the total number of candidates for the output modulation signal Smd can be any number as long as it is of 2 or more. That is, when “(Cmin, Cmax)=(0, X),” any of the modulation signals Smd[0] to Smd[X] can be selected as the output modulation signal Smd, and X can be any integer of 2 or more.

The system SYS in FIG. 9 can be mounted on any electrical equipment. This electrical equipment may be an electrical equipment mounted on a vehicle such as an automobile, may be a computer device, and may be a home appliance or an industrial equipment.

Regarding any signal or voltage, a relationship between their high level and low level may be reversed from what is described above without impairing the essence of the above.

A type of channel of the FET (Field Effect Transistor) shown in the above embodiment is illustrative. The type of channel of any FET can be changed between P-channel type and N-channel type without impairing the essence of the above.

Unless it causes inconvenience, any of the transistors described above may be any type of transistor. For example, any of the transistors described above as a MOSFET may be replaced with a junction FET, IGBT (Insulated Gate Bipolar Transistor), or bipolar transistor, unless it causes inconvenience. Any of the transistors comprises a first electrode, a second electrode, and a control electrode. In an FET, one of the first and second electrodes is a drain, the other is a source, and the control electrode is a gate. In an IGBT, one of the first and second electrodes is a collector, the other is an emitter, and the control electrode is a gate. In a bipolar transistor not belonging to IGBT, one of the first and second electrodes is a collector, the other is an emitter, and the control electrode is a base.

The embodiments of the present disclosure may be variously modified as appropriate within the scope of the technical idea set forth in the claims. The above embodiments are merely examples of the embodiments of the present disclosure, and meanings of terms in the present disclosure and each constituent elements are not limited to those described in the above embodiments. The specific numerical values shown in the above description are merely illustrative, and naturally, they can be changed to various numerical values.

### Appendix

An appendix is provided for the present disclosure in which specific configuration examples are shown in the above embodiments.

A clock signal generation circuit (10) according to one aspect of the present disclosure is a configuration (first configuration) in which the clock signal generation circuit comprises a counter (111) configured to update a count value (CNT) in synchronization with an internal clock signal (CLK1); a timing setting circuit (112) configured to set a sampling timing based on a signal asynchronous to the internal clock signal; a holding circuit (113) configured to acquire and hold the count value at the sampling timing as a parameter value (VAL); a signal generation circuit (114) configured to generate a modulation signal (Smd) having characteristics corresponding to the parameter value held in the holding circuit; and an oscillator (12) configured to generate a target clock signal (CLK2) having a frequency corresponding to the modulation signal.

According to this configuration, the frequency of the target clock signal can be spread with a modulation signal having characteristics corresponding to the parameter value. Since the timing (sampling timing) that acquires the parameter value from the counter is set depending on a signal asynchronous to the internal clock signal, the parameter value becomes random for each sampling timing. Consequently, the modulation signal generated by the signal generation circuit has random characteristics for each sampling timing. As a result, reduction of a peak in a power spectrum of a radiated noise from the clock signal generation circuit or a radiated noise from the device including the clock signal generation circuit can be suppressed. This leads to improved EMI characteristics.

The clock signal generation circuit according to the first configuration may be a configuration (second configuration) in which the signal generation circuit sets a frequency and an amplitude of the modulation signal according to the parameter value.

The clock signal generation circuit according to the first configuration may be a configuration (third configuration) in which the signal generation circuit sets a frequency of the modulation signal according to the parameter value.

The clock signal generation circuit according to the first configuration may be a configuration (fourth configuration) in which the signal generation circuit sets an amplitude of the modulation signal according to the parameter value.

The clock signal generation circuit according to any of the first to fourth configurations may be a configuration (fifth configuration) in which the sampling timing is repeatedly set by the timing setting circuit based on the asynchronous signal, and the parameter value is updated by the holding circuit with the count value at each sampling timing.

The clock signal generation circuit according to any of the first to fourth configurations may be a configuration (sixth configuration) in which a communication signal sent from an external device (200) of a semiconductor device (100) comprising the clock signal generation circuit to the semiconductor device and received by the semiconductor device is used as the asynchronous signal.

By using the communication signal from the external device as the asynchronous signal, the modulation signal generated by the signal generation circuit has random characteristics for each sampling timing. As a result, reduction of the peak in the power spectrum of the radiated noise from the clock signal generation circuit or the radiated noise from the device including the clock signal generation circuit can be suppressed.

The clock signal generation circuit according to the sixth configuration may be a configuration (seventh configuration) in which the timing setting circuit sets the sampling timing based on a timing at which the communication signal is received by the semiconductor device.

The clock signal generation circuit according to the seventh configuration may be a configuration (eighth configuration) in which the communication signal is repeatedly sent from the external device to the semiconductor device, and each time the communication signal is received by the semiconductor device, the sampling timing is set by the timing setting circuit, and the parameter value is updated by the holding circuit with the count value at each sampling timing.

The clock signal generation circuit according to any of the first to fourth configurations may be a configuration (ninth configuration) in which the clock signal generation circuit comprises a frequency divider circuit (14) configured to generate a frequency-divided clock signal (CLK3) by dividing a frequency of the target clock signal, wherein the frequency-divided clock signal is used as the asynchronous signal.

Since the target clock signal generated by the oscillator is asynchronous to the internal clock signal, the frequency-divided clock signal obtained by dividing the target clock signal is also asynchronous to the internal clock signal. Consequently, by using the frequency-divided clock signal as the above asynchronous signal, the modulation signal generated by the signal generation circuit has random characteristics for each sampling timing. As a result, reduction of the peak in the power spectrum of the radiated noise from the clock signal generation circuit or the radiated noise from the device including the clock signal generation circuit can be suppressed.

The clock signal generation circuit according to the ninth configuration may be a configuration (tenth configuration) in which the timing setting circuit sets the sampling timing based on a timing at which a level of the frequency-divided clock signal changes from a first level to a second level.

The clock signal generation circuit according to the tenth configuration may be a configuration (eleventh configuration) in which each time the level of the frequency-divided clock signal changes from the first level to the second level, the sampling timing is set by the timing setting circuit, and the parameter value is updated by the holding circuit with the count value at each sampling timing.

The clock signal generation circuit according to the ninth configuration may be a configuration (twelfth configuration) in which the counter updates the count value during a period from when the level of the frequency-divided clock signal switches from the first level to the second level until it returns to the first level, and the timing setting circuit sets the sampling timing based on a timing at which the level of the frequency-divided clock signal returns to the first level during the period.

The clock signal generation circuit according to the twelfth configuration may be a configuration (thirteenth configuration) in which the sampling timing is set by the timing setting circuit for each period of the frequency-divided clock signal, and the parameter value is updated by the holding circuit with the count value at each sampling timing.

A semiconductor device (100) according to one aspect of the present disclosure is a configuration (fourteenth configuration) in which the semiconductor device comprises a clock signal generation circuit (10) according to any of the first to thirteenth configurations, and a synchronization circuit (21, MM) configured to operate in synchronization with the target clock signal.

By using the clock signal generation circuit according to the present disclosure, reduction of the peak in the power spectrum of radiated noise from the semiconductor device can be suppressed.

A semiconductor device (100) according to another aspect of the present disclosure is a configuration (fifteenth configuration) in which the semiconductor device comprises the clock signal generation circuit (10) according to any of the first to fourth configurations, and a synchronization circuit (21, MM) configured to operate in synchronization with the target clock signal, wherein a communication signal sent from an external device of the semiconductor device to the semiconductor device and received by the semiconductor device is used as an asynchronous signal.

By using communication signals from the external device as the above asynchronous signal, the modulation signal generated by the signal generation circuit has random characteristics at each sampling timing. As a result, reduction in the peak in the power spectrum of radiated noise from the semiconductor device including the clock signal generation circuit can be suppressed.

The semiconductor device according to the fifteenth configuration may be a configuration (sixteenth configuration) in which the timing setting circuit sets the sampling timing based on a timing at which the communication signal is received by the semiconductor device.

The semiconductor device according to the sixteenth configuration may be a configuration (seventeenth configuration) in which the communication signal is repeatedly sent from the external device to the semiconductor device, and each time the communication signal is received by the semiconductor device, the sampling timing is set by the timing setting circuit, and the parameter value is updated by the holding circuit with the count value at each sampling timing.

The semiconductor device according to the seventeenth configuration may be a configuration (eighteenth configuration) in which the external device is configured to repeatedly send the communication signal to the semiconductor device so that the transmission interval of the communication signal falls within a predetermined time range, and a monitoring circuit (60), configured to measure a reception interval (t_{ITVL}) of the communication signal in the semiconductor device and to monitor a presence or absence of an abnormality in the external device based on a measurement result, is provided in the semiconductor device.

As a result, the characteristics of the modulation signal can be randomized using a communication signal that is originally required for abnormality monitoring of the external device.

A semiconductor system according to one aspect of the present disclosure is a configuration (nineteenth configuration) wherein the semiconductor system comprises the semiconductor device according to any of the fifteenth to eighteenth configurations and the external device connected to the semiconductor device.

A power supply control device according to one aspect of the present disclosure is a configuration (twentieth configuration) wherein the power supply control device (100) is provided in a switching power supply device (1) configured to convert an input voltage (Vin) to an output voltage (Vout) through a switching of an output transistor (MH), and comprises the clock signal generation circuit (10) according to any of the first to thirteenth configurations, and a switching controller (21) configured to switch the output transistor at a switching frequency corresponding to the target clock signal.

By using the clock signal generation circuit according to the present disclosure, reduction in the peak in the power spectrum of a radiated noise from the power supply control device or a radiated noise from the switching power supply device including the power supply control device can be suppressed.

1. A clock signal generation circuit, comprising:
a counter configured to update a count value in synchronization with an internal clock signal;
a timing setting circuit configured to set a sampling timing based on a signal asynchronous to the internal clock signal;
a holding circuit configured to acquire and hold the count value at the sampling timing as a parameter value;
a signal generation circuit configured to generate a modulation signal having characteristics corresponding to the parameter value held in the holding circuit; and
an oscillator configured to generate a target clock signal having a frequency corresponding to the modulation signal.

2. The clock signal generation circuit of claim 1, wherein the signal generation circuit sets a frequency and an amplitude of the modulation signal according to the parameter value.

3. The clock signal generation circuit of claim 1, wherein the signal generation circuit sets a frequency of the modulation signal according to the parameter value.

4. The clock signal generation circuit of claim 1, wherein the signal generation circuit sets an amplitude of the modulation signal according to the parameter value.

5. The clock signal generation circuit of claim 1, wherein the sampling timing is repeatedly set by the timing setting circuit based on the asynchronous signal, and the parameter value is updated by the holding circuit with the count value at each sampling timing.

6. The clock signal generation circuit of claim 1, wherein a communication signal sent from an external device of a semiconductor device comprising the clock signal generating circuit to the semiconductor device and received by the semiconductor device is used as the asynchronous signal.

7. The clock signal generation circuit of claim 6, wherein the timing setting circuit sets the sampling timing based on a timing at which the communication signal is received by the semiconductor device.

8. The clock signal generation circuit of claim 7, wherein the communication signal is repeatedly sent from the external device to the semiconductor device, and
each time the communication signal is received by the semiconductor device, the sampling timing is set by the timing setting circuit, and the parameter value is updated by the holding circuit with the count value at each sampling timing.

9. The clock signal generation circuit of claim 1, comprising a frequency divider circuit configured to generate a frequency-divided clock signal by dividing a frequency of the target clock signal,
wherein the frequency-divided clock signal is used as the asynchronous signal.

10. The clock signal generation circuit of claim 9, wherein the timing setting circuit sets the sampling timing based on a timing at which a level of the frequency-divided clock signal changes from a first level to a second level.

11. The clock signal generation circuit of claim 10, wherein each time the level of the frequency-divided clock signal changes from the first level to the second level, the sampling timing is set by the timing setting circuit, and the parameter value is updated by the holding circuit with the count value at each sampling timing.

12. The clock signal generation circuit of claim 9, wherein the counter updates the count value during a period from when the level of the frequency-divided clock signal switches from the first level to the second level until it returns to the first level, and
the timing setting circuit sets the sampling timing based on a timing at which the level of the frequency-divided clock signal returns to the first level during the period.

13. The clock signal generation circuit of claim 12, wherein the sampling timing is set by the timing setting circuit for each period of the frequency-divided clock signal, and the parameter value is updated by the holding circuit with the count value at each sampling timing.

14. A semiconductor device, comprising the clock signal generation circuit of claim 1, and a synchronization circuit configured to operate in synchronization with the target clock signal.

15. A semiconductor device, comprising the clock signal generation circuit of claim 1, and a synchronization circuit configured to operate in synchronization with the target clock signal,
wherein a communication signal sent from an external device of the semiconductor device to the semiconductor device and received by the semiconductor device is used as the asynchronous signal.

16. The semiconductor device of claim 15, wherein the timing setting circuit sets the sampling timing based on a timing at which the communication signal is received by the semiconductor device.

17. The semiconductor device of claim 16, wherein the communication signal is repeatedly sent from the external device to the semiconductor device, and
each time the communication signal is received by the semiconductor device, the sampling timing is set by the timing setting circuit, and the parameter value is updated by the holding circuit with the count value at each sampling timing.

18. The semiconductor device of claim 17, wherein the external device is configured to repeatedly send the communication signal to the semiconductor device so that a transmission interval of the communication signal falls within a predetermined time range, and
a monitoring circuit, configured to measure a reception interval of the communication signal in the semiconductor device and to monitor a presence or absence of an abnormality in the external device based on a measurement result, is provided in the semiconductor device.

19. A semiconductor system, comprising the semiconductor device of claim 15, and the external device connected to the semiconductor device.

20. A power supply control device, provided in a switching power supply device configured to convert an input voltage to an output voltage through a switching of an output transistor, comprising:
the clock signal generation circuit of claim 1; and
a switching controller configured to switch the output transistor at a switching frequency corresponding to the target clock signal.
